(19) United States
(12) Patent Application Publication
(10) Pub. No.: US 2026/0252961 A1
(43) Pub. Date: Aug. 27, 2026

(54) SYSTEM

(71) Applicant: SoftBank Group Corp., Tokyo (JP)

(72) Inventor: Futa SHIMIZU, Tokyo (JP)

(73) Assignee: SoftBank Group Corp., Tokyo (JP)

(21) Appl. No.: 19/539,020

(22) Filed: Feb. 13, 2026

(30) Foreign Application Priority Data
Feb. 21, 2025 (JP) 2025-027025

(51) Int. Cl. G06N 20/00; G06N 3/045; G06V 10/764; G08G 1/01; G08G 1/0967

(52) U.S. Cl. CPC G06N 20/00; G06N 3/045; G06V 10/764; G08G 1/0129; G08G 1/096716

(57) ABSTRACT

The system according to the embodiment comprises a collection unit, an analysis unit, a learning unit, and a determination unit. The collection unit collects the stop time of a vehicle and the number of AI drive recorders within a specific range. The analysis unit analyzes data collected by the collection unit and provides traffic congestion information. The learning unit learns from past driving data and provides route guidance. The determination unit analyzes traffic accident data and determines the degree of fault.

### CROSS-REFERENCE TO RELATED APPLICATION

The present application claims priority to and incorporates by reference the entire contents of Japanese Patent Application No. 2025-027025 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that the accuracy of drive recorders is low, the accuracy of traffic congestion information and route guidance is insufficient, and determining the degree of fault in traffic accidents requires significant time and effort.

### SUMMARY OF THE INVENTION

The system according to the embodiment comprises a collection unit, an analysis unit, a learning unit, and a determination unit. The collection unit collects the stop time of a vehicle and the number of AI drive recorders within a specific range. The analysis unit analyzes data collected by the collection unit and provides traffic congestion information. The learning unit learns from past driving data and provides route guidance. The determination unit analyzes traffic accident data and determines the degree of fault.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

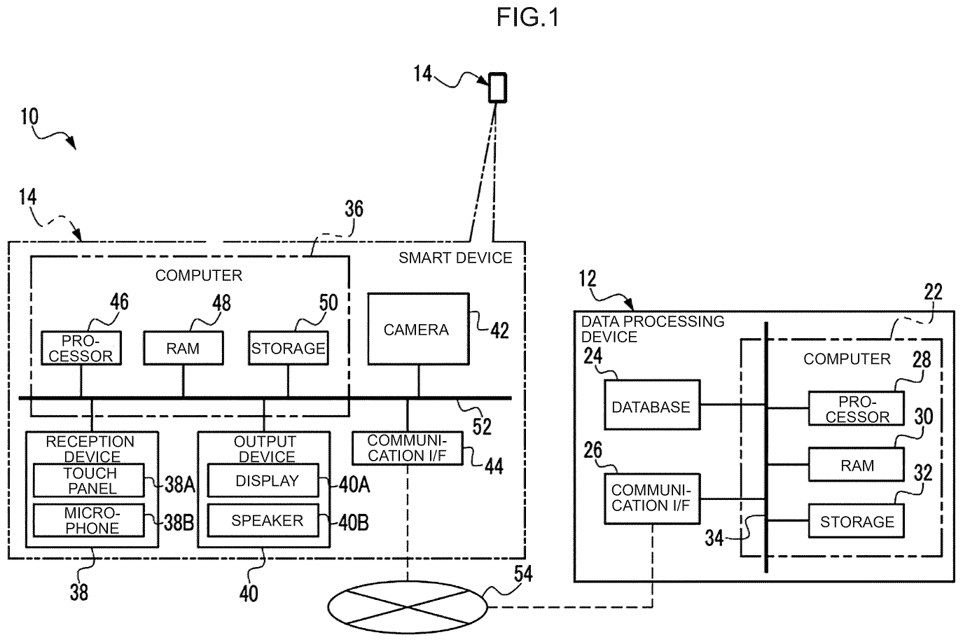

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

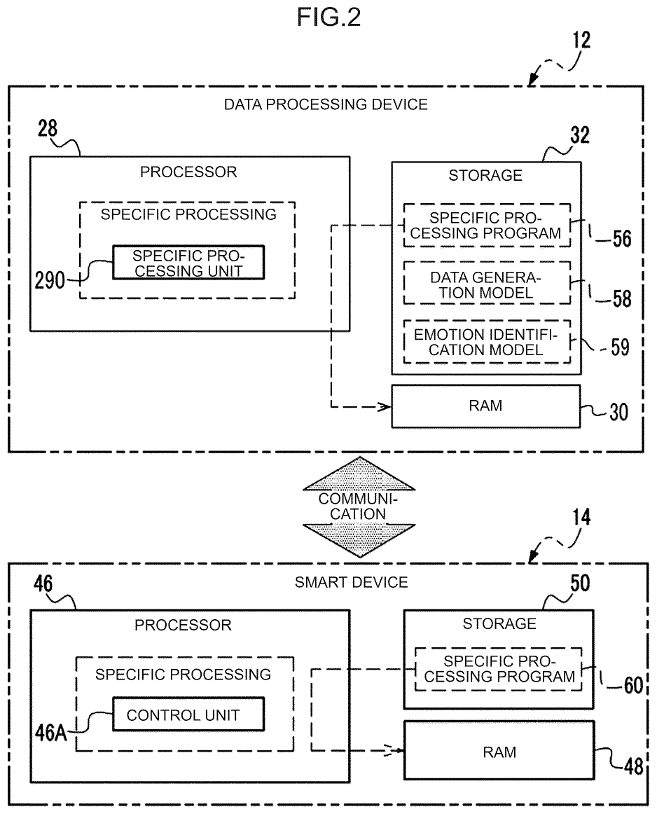

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The system according to the embodiment of the present invention is a system that improves the accuracy of traffic congestion information and enables rapid determination of the degree of fault in traffic accidents by installing AI-equipped drive recorders (AI drive recorders) in each vehicle. This system collects, in real time, the stop time of a vehicle and the number of nearby AI drive recorders to grasp the occurrence of traffic congestion. For example, if multiple vehicles are stopped for a long time at a certain location, the system can determine that congestion is occurring based on this information and propose detour routes to other vehicles. Furthermore, the AI drive recorder learns from past driving data and provides efficient route guidance. For example, by learning congestion occurrence patterns and road congestion conditions for specific time periods, the system can propose optimal routes. Additionally, when a traffic accident occurs, the AI drive recorder analyzes vehicle speed and location information at the time of the accident, as well as precedent data, to provide a mechanism for rapid determination of the degree of fault at the scene. For example, by analyzing video footage and data at the moment of the accident and comparing them with past precedents, the system can automatically calculate the degree of fault. As a result, the degree of fault can be determined quickly at the scene without waiting for intervention from an insurance company, thereby reducing the time and stress required for resolution. Thus, the AI-equipped drive recorder system can improve the accuracy of traffic congestion information and realize efficient route guidance. Moreover, by rapidly determining the degree of fault in traffic accidents, the time and stress required for resolution can be reduced. Specifically, this system uses AI drive recorders as edge devices installed in each vehicle to collect, in real time, the stop time of a vehicle (e.g., time-series data in seconds, float array, e.g., {12.3, 0.0, 5.7, . . . }) and the number of nearby AI drive recorders (integer values, e.g., 5 units, 12 units, etc.). The system transmits these data as time-series tensors to a cloud or local server, where the analysis unit uses convolutional neural networks (CNN) or recurrent neural networks (RNN) to output the presence or absence of congestion (binary label: 0=no congestion, 1=congestion), the degree of congestion (continuous score: 0.0-1.0), and the predicted time of occurrence (e.g., 5 minutes later, 15 minutes later, etc.). For example, input examples include “stop time vector: {10.2, 12.5, 15.0}”, “number of nearby units: 8”, “driving history tensor for the past 30 minutes”, and output examples include “congestion occurrence probability 0.85”, “recommended detour route ID: 23”. The analysis unit links these outputs to threshold determination (e.g., congestion is determined if 0.7 or higher) and route recommendation modules, and distributes information to other vehicles or displays navigation. Furthermore, the AI drive recorder uses past driving data (e.g., GPS coordinate sequences, speed time series, day-of-week and time labels) as training data to learn with deep learning models (e.g., Transformer-based time-series prediction models), automatically extracting congestion occurrence patterns and optimal routes under specific days, times, and weather conditions. The trained model receives new driving data as input during inference and outputs optimal route candidates (e.g., route ID, estimated travel time, congestion score, etc.). In the event of a traffic accident, the determination unit inputs video frames immediately before and after the accident (image tensor: 3D array, e.g., 224×224×3), vehicle speed (float value), location information (latitude and longitude pair), and accident precedent database (structured table: accident type, degree of fault, precedent ID, etc.), applies image recognition models (e.g., ResNet) and precedent matching algorithms (e.g., similarity calculation, k-NN, etc.), and automatically calculates the degree of fault (e.g., vehicle A 70%, vehicle B 30%). Output examples include “degree of fault: vehicle A 60%, vehicle B 40%”, “reference precedent ID: 10234”. These outputs are immediately displayed on on-site terminals or smartphones, enabling users and stakeholders to quickly reach consensus. The technical effect of this system is that it eliminates subjective human judgment and manual information collection/analysis, and by automatically analyzing vast time-series, image, and precedent data in high-dimensional space, greatly improves the accuracy and speed of congestion detection, route recommendation, and degree of fault determination. In addition, distributed processing and edge-cloud collaboration considering communication load achieve both real-time performance and scalability. Application fields include urban traffic control, optimization of logistics vehicle operations, automation of accident response for insurance companies, and selection of priority routes for emergency vehicles. By realizing non-conventional, rule-based, data-driven traffic information processing that does not rely on human visual inspection, heuristics, or manual input, this invention contributes to the improvement of computer technology itself.

The AI drive recorder system according to the embodiment comprises a collection unit, an analysis unit, a learning unit, and a determination unit. The collection unit collects the stop time of a vehicle and the number of nearby AI drive recorders. For example, the collection unit measures the stop time of a vehicle and counts the number of AI drive recorders within a specific range. The collection unit can measure the stop time of a vehicle in real time and count the number of AI drive recorders within a specific range in real time. The analysis unit analyzes data collected by the collection unit and provides traffic congestion information. For example, the analysis unit determines the occurrence of congestion based on the collected data and generates traffic congestion information. The analysis unit can predict the time of congestion occurrence and the degree of congestion based on the collected data and provide traffic congestion information. The learning unit learns from past driving data and provides efficient route guidance. For example, the learning unit proposes optimal routes based on past driving data. The learning unit can learn congestion patterns for specific time periods and days of the week and provide efficient route guidance. The determination unit analyzes traffic accident data and determines the degree of fault. For example, the determination unit analyzes video footage and data at the moment of the accident and calculates the degree of fault by comparing with past precedents. The determination unit can refer to different precedent data according to the situation of the accident and determine the degree of fault. Thus, the AI drive recorder system according to the embodiment can improve the accuracy of traffic congestion information and realize efficient route guidance. Moreover, by rapidly determining the degree of fault in traffic accidents, the time and stress required for resolution can be reduced. Specifically, the AI drive recorder system uses AI drive recorders as edge devices installed in each vehicle to obtain the stop time of a vehicle as time-series data in seconds (float array, e.g., 12.3, 0.0, 5.7, . . . ) and measure the number of nearby AI drive recorders as integer values (e.g., 5 units, 12 units, etc.). The collection unit transmits these data as time-series tensors to a cloud or local server, where the analysis unit uses convolutional neural networks (CNN) or recurrent neural networks (RNN) to output the presence or absence of congestion (binary label: 0=no congestion, 1=congestion), the degree of congestion (continuous score: 0.0-1.0), and the predicted time of occurrence (e.g., 5 minutes later, 15 minutes later, etc.). Input examples include “stop time vector: 10.2, 12.5, 15.0”, “number of nearby units: 8”, “driving history tensor for the past 30 minutes”, and output examples include “congestion occurrence probability 0.85”, “recommended detour route ID: 23”. The analysis unit links these outputs to threshold determination (e.g., congestion is determined if 0.7 or higher) and route recommendation modules, and distributes information to other vehicles or displays navigation. The learning unit uses past driving data (e.g., GPS coordinate sequences, speed time series, day-of-week and time labels) as training data to learn with deep learning models (e.g., Transformer-based time-series prediction models), automatically extracting congestion occurrence patterns and optimal routes under specific days, times, and weather conditions. The trained model receives new driving data as input during inference and outputs optimal route candidates (e.g., route ID, estimated travel time, congestion score, etc.). The determination unit inputs video frames immediately before and after the accident (image tensor: 3D array, e.g., 224×224×3), vehicle speed (float value), location information (latitude and longitude pair), and accident precedent database (structured table: accident type, degree of fault, precedent ID, etc.), applies image recognition models (e.g., ResNet) and precedent matching algorithms (e.g., similarity calculation, k-NN, etc.), and automatically calculates the degree of fault (e.g., vehicle A 70%, vehicle B 30%). Output examples include “degree of fault: vehicle A 60%, vehicle B 40%”, “reference precedent ID: 10234”. These outputs are immediately displayed on on-site terminals or smartphones, enabling users and stakeholders to quickly reach consensus. The technical effect of this system is that it eliminates subjective human judgment and manual information collection/analysis, and by automatically analyzing vast time-series, image, and precedent data in high-dimensional space, greatly improves the accuracy and speed of congestion detection, route recommendation, and degree of fault determination. In addition, distributed processing and edge-cloud collaboration considering communication load achieve both real-time performance and scalability. Application fields include urban traffic control, optimization of logistics vehicle operations, automation of accident response for insurance companies, and selection of priority routes for emergency vehicles. By realizing non-conventional, rule-based, data-driven traffic information processing that does not rely on human visual inspection, heuristics, or manual input, this invention contributes to the improvement of computer technology itself.

The collection unit comprises a provision unit configured to provide collected data to other vehicles. The provision unit provides data collected by the collection unit to other vehicles. For example, the provision unit transmits the collected data to other vehicles in real time. The provision unit can provide the collected data to other vehicles within the communication range. By providing collected data to other vehicles, wide-area sharing of traffic congestion information becomes possible. Some or all of the above-described processing in the provision unit may be performed using AI or without using AI. For example, the provision unit can input the collected data into an AI model to generate information to be provided to other vehicles. Specifically, the provision unit of this system integrates various data received from the collection unit, such as vehicle stop time (float array in seconds, e.g., 12.3, 0.0, 5.7, . . . ), number of nearby AI drive recorders (integer values, e.g., 5, 12), changes in vehicle speed (time-series vector), number of sudden brakes (integer value), weather and road condition data (category labels or continuous values, e.g., rainy=1, clear=0, road surface temperature=15.2° C.), and transmits them in real time to edge devices of other vehicles or cloud servers via a communication module. The provision unit uses packet structures compliant with V2V (Vehicle-to-Vehicle) or V2X (Vehicle-to-Everything) standards as communication protocols and can dynamically control the identification of destination vehicles and communication range (e.g., within a radius of 500 m). Furthermore, the provision unit can not only transmit the collected data as is, but also input it into convolutional neural networks (CNN), recurrent neural networks (RNN), or Transformer-based time-series analysis models to generate information such as congestion occurrence probability (e.g., 0.85), recommended detour route ID (e.g., 23), and danger location labels (e.g., locations with frequent sudden brakes), and provide these to other vehicles. Input examples for the AI model include “stop time vector: {10.2, 12.5, 15.0}”, “number of nearby units: 8”, “driving history tensor for the past 30 minutes”, “weather data: rain, temperature 12.5° C.”. Output examples from the AI model include “congestion occurrence probability 0.92”, “recommended route ID: 45”, “danger score 0.78”. These outputs are used for subsequent processing such as threshold determination (e.g., generating warning information if congestion occurrence probability is 0.7 or higher) and information prioritization (e.g., immediate notification if danger score is high), and are ultimately distributed to navigation systems or driver terminals of other vehicles. The technical effect of the provision unit is that it eliminates manual information sharing and visual confirmation by humans, and by automatically analyzing and distributing vast time-series and multivariate data in real time, greatly improves the accuracy and immediacy of wide-area traffic information. In addition, information generation and prioritization by AI enable efficient use of communication bandwidth and selective distribution of important information, thereby reducing network load and improving scalability. Application fields include urban traffic control, platoon driving control for logistics vehicles, priority passage support for emergency vehicles, and traffic information sharing during disasters. Unlike conventional human-dependent information sharing, this invention realizes non-conventional, rule-based, data-driven information distribution by combining AI and communication technology, thereby contributing to the improvement of computer technology itself.

The protection unit anonymizes and encrypts data. The protection unit anonymizes and encrypts collected data. For example, the protection unit deletes personal information from collected data to anonymize it. The protection unit can also encrypt collected data to prevent unauthorized access by third parties. Thus, anonymization and encryption of data improve data security. Some or all of the above-described processing in the protection unit may be performed using AI or without using AI. For example, the protection unit can input collected data into an AI model to perform anonymization and encryption. Specifically, the protection unit receives datasets such as vehicle stop time, location information (latitude and longitude), vehicle ID, user attributes (age, gender, etc.), and driving history (GPS coordinate sequences, speed time series) from the collection unit, and applies anonymization algorithms that automatically detect and delete attributes that can identify personal information (e.g., vehicle ID, user ID, face images, license plate images). The protection unit uses rule-based masking (e.g., converting IDs to hash values, masking face regions in images by image processing) or generative models (e.g., GAN for image inpainting, LLM for text anonymization) to irreversibly remove personal information. Input examples for the AI model include “vehicle ID: 12345”, “driving history: {35.123, 139.456, . . . }”, “face image tensor: 224×224×3”; output examples include “vehicle ID: hash value”, “face image: masked”, “driving history: anonymized coordinates”. Furthermore, the protection unit encrypts the anonymized data using public-key cryptography such as AES or RSA, or quantum-resistant encryption algorithms, to prevent unauthorized access or tampering during transmission or storage. When using AI models, automatic detection of abnormal patterns of residual personal information and dynamic optimization of encryption strength (e.g., switching encryption methods according to communication partner or usage purpose) can also be realized. Output examples include “encrypted data binary”, “anonymized JSON structure”. These outputs are used for subsequent data distribution and analysis processing, with access control according to decryption authority and anonymization level. The technical effect of the protection unit is that it eliminates manual masking of personal information and encryption settings by humans, and by combining AI and encryption technology to automatically anonymize and encrypt high-dimensional, diverse data, greatly improves the accuracy and efficiency of data security and privacy protection. Furthermore, automation of anonymization and encryption processing ensures real-time performance and scalability for large-scale data distribution. Application fields include vehicle data distribution platforms, accident data management for insurance companies, urban traffic big data analysis, and systems for compliance with personal information protection laws. Unlike conventional human-dependent, manually configured security measures, this invention realizes non-conventional, rule-based data protection by integrating AI and encryption technology, thereby contributing to the improvement of computer technology itself.

The management unit manages precedent data. The management unit manages precedent data. For example, the management unit collects precedent data and stores it in a database. The management unit can periodically update precedent data and provide the latest data. Thus, management of precedent data enables rapid and accurate determination of the degree of fault. Some or all of the above-described processing in the management unit may be performed using AI or without using AI. For example, the management unit can input precedent data into an AI model to perform data management. Specifically, the management unit manages an accident precedent database (structured table: accident type, degree of fault, precedent ID, occurrence date and time, summary of judgment, related laws, etc.), automatically collects new precedent data from external precedent publication APIs or court databases, matches and deduplicates with existing databases, normalizes the data, and integrates the latest precedent information for unified management. The management unit implements functions such as indexing, full-text search, version control, and access restriction on a database management system (RDBMS or NoSQL), enabling rapid response to search and reference requests from users or the determination unit. When using AI models, the management unit inputs precedent texts and metadata into natural language processing models (e.g., Transformer-based text classifiers or summarization models) to calculate similarity scores with accident situations (e.g., cosine similarity 0.92), automatically extract related precedents (e.g., top 3 precedent IDs), and automatically summarize precedent summaries (e.g., 100-character summary). Input examples for AI include “accident situation text: collision during right turn at intersection”, “precedent database: 10,000 cases”, “search query: degree of fault 70% vs 30%”; output examples include “similar precedent ID: 10234”, “summary: higher degree of fault for right-turning vehicle”, “related law: Road Traffic Act Article XX”. These outputs are used for subsequent processing such as calculation of degree of fault by the determination unit, explanation display to users, and report generation for insurance companies. The technical effect of the management unit is that it eliminates manual collection, organization, and search of precedents by humans, and by combining AI and database technology to automatically manage, search, and summarize large-scale, diverse precedent data, simultaneously achieves rapidity, accuracy, and explainability in degree of fault determination. Furthermore, automation of periodic updates, quality monitoring, and access control of precedent data ensures reliability, security, and scalability. Application fields include automation of accident response for insurance companies, precedent search support for legal departments, and database operation for traffic accident investigation agencies. Unlike conventional human-dependent, manual search-based precedent management, this invention realizes non-conventional, rule-based precedent data management by integrating AI and database technology, thereby contributing to the improvement of computer technology itself.

The collection unit collects, in real time, the stop time of a vehicle and the number of nearby AI drive recorders. The collection unit collects, in real time, the stop time of a vehicle and the number of nearby AI drive recorders. For example, the collection unit can measure the stop time of a vehicle in real time and count the number of AI drive recorders within a specific range in real time. The collection unit can measure the stop time of a vehicle in real time and count the number of AI drive recorders within a specific range in real time. Thus, real-time data collection enables the provision of up-to-date traffic congestion information. Some or all of the above-described processing in the collection unit may be performed using AI or without using AI. For example, the collection unit can input the stop time of a vehicle and the number of nearby AI drive recorders into an AI model to collect data in real time. Specifically, the collection unit uses AI drive recorders as edge devices installed in each vehicle to obtain the stop time of a vehicle as time-series data in seconds (float array, e.g., 12.3, 0.0, 5.7, . . . ) and measure the number of nearby AI drive recorders as integer values (e.g., 5 units, 12 units, etc.). The collection unit structures these data as time-series tensors (e.g., N×2 matrix, N is the number of observation times, each row is [stop time, number of nearby units]) and transmits them in real time to a cloud or local server. Furthermore, the collection unit adds metadata such as GPS coordinates, timestamps, and vehicle IDs during data collection to ensure spatial and temporal consistency of the data. When using AI models, the collection unit inputs stop time vectors and nearby unit vectors to automatically perform preprocessing such as anomaly detection (e.g., sudden increase in stops), data imputation (e.g., interpolation during sensor failure), and noise removal (e.g., filtering erroneous detections due to disturbances). Input examples include “stop time vector: {10.2, 12.5, 15.0}”, “number of nearby units: 8”, “GPS coordinates: 35.123, 139.456”; output examples from the AI model include “anomaly detection flag: 0”, “imputed stop time: 11.3”. These outputs are attached as reliability labels or data quality indicators when transferring data to subsequent analysis or provision units. The technical effect of the collection unit is that it eliminates manual measurement and visual counting by humans, and by automatically collecting and preprocessing vast time-series and multivariate data in real time, greatly improves the freshness, accuracy, and reliability of traffic congestion information. In addition, anomaly detection and noise removal by AI reduce the impact of sensor malfunctions and disturbances, suppressing the risk of erroneous judgments in the analysis unit. Application fields include urban traffic control, optimization of logistics vehicle operations, selection of priority routes for emergency vehicles, and traffic data infrastructure for smart cities. Unlike conventional human-dependent, manual collection of traffic data, this invention realizes non-conventional, rule-based real-time data collection by combining AI and edge devices, thereby contributing to the improvement of computer technology itself.

The analysis unit analyzes collected data and provides traffic congestion information. The analysis unit analyzes collected data and provides traffic congestion information. For example, the analysis unit determines the occurrence of congestion based on the collected data and generates traffic congestion information. The analysis unit can predict the time of congestion occurrence and the degree of congestion based on the collected data and provide traffic congestion information. Thus, data analysis enables the provision of highly accurate traffic congestion information. Some or all of the above-described processing in the analysis unit may be performed using AI or without using AI. For example, the analysis unit can input collected data into an AI model to generate traffic congestion information. Specifically, the analysis unit integrates multidimensional data received from the collection unit, such as stop time of a vehicle (float time-series vector in seconds, e.g., {12.3, 0.0, 5.7, . . . }), number of nearby AI drive recorders (integer values, e.g., 5, 12), changes in vehicle speed (time-series vector), number of sudden brakes (integer value), weather and road condition data (category labels or continuous values, e.g., rainy=1, clear=0, road surface temperature=15.2), and structures them as time-series tensors (e.g., N×M matrix, N is the number of observation times, M is the number of features). The analysis unit uses convolutional neural networks (CNN), recurrent neural networks (RNN), or Transformer-based time-series analysis models to output from the input tensor the presence or absence of congestion (binary label: 0=no congestion, 1=congestion), the degree of congestion (continuous score: 0.0-1.0), predicted time of occurrence (e.g., 5 minutes later, 15 minutes later), recommended detour route ID (integer value), and danger location labels (e.g., locations with frequent sudden brakes). Input examples for the AI model include “stop time vector: {10.2, 12.5, 15.0}”, “number of nearby units: 8”, “driving history tensor for the past 30 minutes”, “weather data: rain, temperature 12.5”; output examples include “congestion occurrence probability 0.92”, “recommended route ID: 45”, “danger score 0.78”. The analysis unit uses these outputs for subsequent processing such as threshold determination (e.g., generating warning information if congestion occurrence probability is 0.7 or higher) and information prioritization (e.g., immediate notification if danger score is high), and ultimately distributes them to navigation systems or driver terminals of other vehicles. During AI model training, the analysis unit uses past congestion occurrence history, road congestion patterns, day-of-week, time, and weather conditions as training data, and optimizes weights by error backpropagation based on loss functions (e.g., cross-entropy, MSE). The analysis unit also automates preprocessing such as anomaly detection, noise removal, and data imputation to improve data quality. The technical effect of the analysis unit is that it eliminates subjective human judgment and manual information analysis, and by automatically analyzing vast time-series and multivariate data in high-dimensional space, greatly improves the accuracy and speed of congestion detection and route recommendation. In addition, distributed processing and edge-cloud collaboration considering communication load achieve both real-time performance and scalability. Application fields include urban traffic control, optimization of logistics vehicle operations, selection of priority routes for emergency vehicles, and traffic data infrastructure for smart cities. Unlike conventional human-dependent, manual analysis of traffic information, this invention realizes non-conventional, rule-based real-time data analysis by combining AI and edge devices, thereby contributing to the improvement of computer technology itself.

The learning unit learns from past driving data and provides efficient route guidance. The learning unit learns from past driving data and provides efficient route guidance. For example, the learning unit proposes optimal routes based on past driving data. The learning unit can learn congestion patterns for specific time periods and days of the week and provide efficient route guidance. Thus, learning from past data enables efficient route guidance. Some or all of the above-described processing in the learning unit may be performed using AI or without using AI. For example, the learning unit can input past driving data into an AI model to propose optimal routes. Specifically, the learning unit uses driving history data collected from each vehicle and other vehicles (e.g., GPS coordinate sequences, speed time series, day-of-week and time labels, weather and road conditions, traffic signal changes, construction information, etc.) as training data to learn using deep learning models (e.g., Transformer-based time-series prediction models, LSTM, GRU, or graph neural networks). The learning unit receives input data such as “driving history tensor: N×T×F (N is the number of vehicles, T is the time-series length, F is the number of features)”, “day-of-week and time: Monday 8 a.m.”, “weather: rain”, “construction section: present”, and outputs “optimal route ID”, “estimated travel time (e.g., 23 minutes)”, “congestion score (e.g., 0.72)”. The learning unit uses loss functions such as travel time error, congestion error, and route selection accuracy, and optimizes model parameters by error backpropagation. The learning unit also automates preprocessing such as data augmentation (e.g., time-series shift of driving history, synthesis of weather conditions), anomaly removal, and feature selection to improve model generalization performance. The learning unit receives new driving data (e.g., current location, destination, time, weather) as input during inference and outputs optimal route candidates (route ID, travel time, congestion score, recommendation reason, etc.). Output examples include “route ID: 12”, “travel time: 18 minutes”, “congestion: 0.35”. The learning unit links these outputs to route recommendation modules and navigation display units to provide users with optimal route guidance. The technical effect of the learning unit is that it eliminates human heuristics and manual route selection, and by automatically learning vast time-series and multivariate data in high-dimensional space, greatly improves the accuracy, efficiency, and adaptability of route guidance. In addition, it can flexibly respond to abnormal weather and sudden traffic changes. Application fields include urban traffic control, optimization of logistics vehicle operations, congestion avoidance in tourist areas, and selection of priority routes for emergency vehicles. Unlike conventional human-dependent, manual learning-based route guidance, this invention realizes non-conventional, rule-based automatic route guidance by combining AI and time-series analysis technology, thereby contributing to the improvement of computer technology itself.

The determination unit analyzes traffic accident data and determines the degree of fault. The determination unit analyzes traffic accident data and determines the degree of fault. For example, the determination unit analyzes video footage and data at the moment of the accident and calculates the degree of fault by comparing with past precedents. The determination unit can refer to different precedent data according to the situation of the accident and determine the degree of fault. Thus, analysis of traffic accident data enables rapid and accurate determination of the degree of fault. Some or all of the above-described processing in the determination unit may be performed using AI or without using AI. For example, the determination unit can input traffic accident data into an AI model to calculate the degree of fault. Specifically, the determination unit integrates various data such as video frames immediately before and after the accident (image tensor: 3D array, e.g., 224×224×3), vehicle speed (float value), location information (latitude and longitude pair), accident occurrence time, weather and road conditions, driving style and number of sudden brakes of related vehicles, and accident precedent database (structured table: accident type, degree of fault, precedent ID, occurrence date and time, summary of judgment, related laws, etc.), and inputs them into an AI model. The determination unit uses image recognition models (e.g., ResNet, EfficientNet, etc.) to classify accident types (e.g., rear-end collision, side collision, collision during right turn, etc.) from accident footage, and natural language processing models (e.g., Transformer-based text classifiers or summarization models) to analyze accident situation descriptions and precedent summaries. The determination unit uses precedent matching algorithms (e.g., similarity calculation, k-NN, vector search) to extract similar cases from the precedent database based on the input accident situation, and automatically calculates the degree of fault (e.g., vehicle A 70%, vehicle B 30%), reference precedent ID, and related laws. Input examples for the AI model include “accident footage tensor: 224×224×3”, “vehicle speed: 35.2 km/h”, “location information: 35.123, 139.456”, “accident situation text: collision during right turn at intersection”, “precedent database: 10,000 cases”; output examples include “degree of fault: vehicle A 60%, vehicle B 40%”, “reference precedent ID: 10234”, “summary: higher degree of fault for right-turning vehicle”. The determination unit immediately displays these outputs on on-site terminals or smartphones, enabling users and stakeholders to quickly reach consensus. During training, the determination unit uses accident footage, situations, and precedent data as training data, and optimizes the model using loss functions (e.g., cross-entropy, similarity error). The technical effect of the determination unit is that it eliminates subjective human judgment and manual information collection/analysis, and by automatically analyzing vast image, time-series, text, and precedent data in high-dimensional space, greatly improves the accuracy and speed of degree of fault determination. In addition, highly explainable precedent references and summary generation improve user satisfaction and transparency. Application fields include automation of accident response for insurance companies, precedent search support for legal departments, and database operation for traffic accident investigation agencies. Unlike conventional human-dependent, manual determination of accident analysis, this invention realizes non-conventional, rule-based automatic degree of fault determination by integrating AI and database technology, thereby contributing to the improvement of computer technology itself.

The collection unit estimates a user's emotion and adjusts the data collection frequency based on the estimated user's emotion. The collection unit estimates a user's emotion and adjusts the data collection frequency based on the estimated user's emotion. For example, if the user is feeling stressed, the collection unit increases the collection frequency to provide detailed information in real time. If the user is relaxed, the collection unit decreases the collection frequency to reduce battery consumption. If the user is in a hurry, the collection unit increases the collection frequency to provide information quickly. Thus, by adjusting the data collection frequency according to the user's emotion, more appropriate information provision becomes possible. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the collection unit may be performed using AI or without using AI. For example, the collection unit can input user emotion data into generative AI to adjust the data collection frequency. Specifically, the collection unit acquires various emotion-related data such as user voice data (e.g., waveform tensor of conversation audio), face images (e.g., 224×224×3 image tensor), driving behavior (e.g., time-series of steering operations, pedal force vector), and biometric sensor data (e.g., heart rate, skin conductance), and inputs them into a multimodal generative AI model (e.g., speech emotion recognition CNN+facial expression recognition CNN+time-series RNN+text generation LLM). The AI model outputs “emotion label (e.g., stress, relaxation, impatience)” and “emotion intensity score (e.g., 0.85)” from the input data. Output examples include “emotion: stress, intensity 0.92”, “emotion: relaxation, intensity 0.35”. The collection unit dynamically sets data collection frequency parameters (e.g., every 1 second, every 10 seconds, every 1 minute) based on these emotion estimation results, automating control such that frequency is high during stress and low during relaxation. Furthermore, the collection unit can apply algorithms (e.g., reinforcement learning-based parameter optimization) that determine optimal collection frequency by combining emotion estimation results with battery level and communication bandwidth status. The technical effect of the collection unit is that it eliminates subjective human judgment and manual setting for collection frequency adjustment, and by realizing automatic optimization that comprehensively considers emotional state, driving situation, and system resources, greatly improves the timeliness, accuracy, and user experience of information provision. Application fields include stress management navigation, driving support systems, personalized information distribution in smart cities, and vehicle fleet management. Unlike conventional human-dependent, fixed-setting data collection, this invention realizes non-conventional, rule-based automatic collection frequency control by integrating AI and multimodal emotion estimation technology, thereby contributing to the improvement of computer technology itself.

The collection unit collects not only the stop time of a vehicle but also changes in vehicle speed and the number of sudden brakes. The collection unit collects not only the stop time of a vehicle but also changes in vehicle speed and the number of sudden brakes. For example, if the vehicle speed drops sharply, the collection unit collects data at that location. The collection unit can collect data at locations where sudden brakes occur frequently and mark them as danger spots. The collection unit can combine stop time and changes in speed to grasp the occurrence of congestion in detail. Thus, by collecting changes in vehicle speed and the number of sudden brakes, more detailed traffic congestion information can be provided. Some or all of the above-described processing in the collection unit may be performed using AI or without using AI. For example, the collection unit can input data on changes in vehicle speed and sudden brakes into generative AI to generate detailed traffic congestion information. Specifically, the collection unit uses AI drive recorders as edge devices installed in each vehicle to obtain, in real time, the stop time of a vehicle (float array in seconds, e.g., 12.3, 0.0, 5.7, . . . ), changes in vehicle speed (time-series vector, e.g., {50.0, 48.2, 30.1, . . . }), and the number of sudden brakes (integer value, e.g., 3 times, 7 times, etc.). The collection unit structures these data as time-series tensors (e.g., N×3 matrix, N is the number of observation times, each row is [stop time, speed, sudden brake flag]) and transmits them to a cloud or local server. Furthermore, the collection unit adds metadata such as GPS coordinates, timestamps, and vehicle IDs to ensure spatial and temporal consistency. When using AI models, the collection unit inputs speed change vectors and sudden brake flags to automatically perform preprocessing such as abnormal driving detection (e.g., automatic extraction of sudden deceleration patterns), danger spot clustering (e.g., automatic marking of locations with frequent sudden brakes), and congestion precursor detection (e.g., simultaneous occurrence of speed decrease and increase in stop time). Input examples for AI include “speed change vector: {50.0, 48.2, 30.1}”, “number of sudden brakes: 2”, “stop time: {0.0, 0.0, 5.7}”; output examples from the AI model include “danger spot label: frequent sudden brakes”, “congestion precursor score: 0.81”. These outputs are attached as reliability labels or danger indicators when transferring data to subsequent analysis or provision units. The technical effect of the collection unit is that it eliminates manual speed measurement and danger spot identification by humans, and by automatically collecting and preprocessing vast time-series and multivariate data in real time, greatly improves the freshness, accuracy, and reliability of traffic congestion and danger spot information. In addition, abnormal driving detection and danger spot clustering by AI realize non-conventional, rule-based, data-driven traffic information processing, unlike conventional human-dependent, heuristic information collection. Application fields include urban traffic control, optimization of logistics vehicle operations, automatic extraction of accident-prone locations, and automation of risk assessment for insurance companies. Thus, this invention simultaneously achieves improvement of computer technology itself, namely real-time performance, scalability, accuracy improvement, and reduction of erroneous judgments.

The collection unit also collects data on weather and road conditions to improve the accuracy of traffic congestion information. The collection unit also collects data on weather and road conditions to improve the accuracy of traffic congestion information. For example, the collection unit collects road condition data during rainy weather to identify slippery locations. The collection unit can collect road condition data on snowy days to identify locations that require snow removal. The collection unit can collect meteorological data such as wind speed and temperature to analyze factors causing congestion. Thus, by collecting data on weather and road conditions, the accuracy of traffic congestion information is improved. Some or all of the above-described processing in the collection unit may be performed using AI or without using AI. For example, the collection unit can input data on weather and road conditions into generative AI to improve the accuracy of traffic congestion information. Specifically, the collection unit uses edge devices installed in each vehicle or external sensor networks to obtain weather data (e.g., temperature, humidity, precipitation, wind speed, atmospheric pressure, weather labels: clear, rain, snow, etc.) and road condition data (e.g., road surface temperature, road surface friction coefficient, snow depth, road surface freezing flag, road surface damage score, etc.) in real time. The collection unit structures these data as time-series tensors (e.g., N×M matrix, N is the number of observation times, M is the number of features) and transmits them to a cloud or local server. Furthermore, the collection unit integrates external data from meteorological agency APIs and road management systems to ensure spatial and temporal consistency. When using AI models, the collection unit inputs weather and road condition vectors to automatically perform preprocessing such as abnormal weather detection (e.g., automatic determination of heavy rain or heavy snow), danger spot estimation (e.g., automatic extraction of slippery road surfaces), and analysis of congestion factors (e.g., correlation analysis between temperature drop and congestion occurrence). Input examples for AI include “weather data: rain, temperature 12.5° C., humidity 85%”, “road surface temperature: 3.2° C.”, “road surface friction coefficient: 0.35”; output examples from the AI model include “danger spot label: slippery”, “snow removal required flag: 1”, “congestion factor score: 0.78”. These outputs are attached as danger indicators or caution area labels when transferring data to subsequent analysis or provision units. The technical effect of the collection unit is that it eliminates manual weather observation and road condition confirmation by humans, and by automatically collecting and preprocessing vast time-series and multivariate data in real time, greatly improves the freshness, accuracy, and reliability of traffic congestion and danger spot information. In addition, abnormal weather detection and factor analysis by AI realize non-conventional, rule-based, data-driven traffic information processing, unlike conventional human-dependent, heuristic information collection. Application fields include urban traffic control, winter road management, optimization of logistics vehicle operations, and traffic information sharing during disasters. Thus, this invention simultaneously achieves improvement of computer technology itself, namely real-time performance, scalability, accuracy improvement, and reduction of erroneous judgments.

The collection unit estimates a user's emotion and determines the priority of data to be collected based on the estimated user's emotion. The collection unit estimates a user's emotion and determines the priority of data to be collected based on the estimated user's emotion. For example, if the user is feeling stressed, the collection unit prioritizes the collection of traffic congestion information. If the user is relaxed, the collection unit prioritizes the collection of nearby sightseeing information. If the user is in a hurry, the collection unit prioritizes the collection of shortest route information. Thus, by determining the priority of data to be collected according to the user's emotion, more appropriate information provision becomes possible. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the collection unit may be performed using AI or without using AI. For example, the collection unit can input user emotion data into generative AI to determine the priority of data to be collected. Specifically, the collection unit acquires various emotion-related data such as user voice data (e.g., waveform tensor of conversation audio), face images (e.g., 224×224×3 image tensor), driving behavior (e.g., time-series of steering operations, pedal force vector), and biometric sensor data (e.g., heart rate, skin conductance), and inputs them into a multimodal generative AI model (e.g., speech emotion recognition CNN+facial expression recognition CNN +time-series RNN+text generation LLM). The collection unit obtains outputs from the AI model such as “emotion label (e.g., stress, relaxation, impatience)” and “emotion intensity score (e.g., 0.85)”. Input examples include “audio waveform tensor: 1×16000”, “face image tensor: 224×224×3”, “heart rate: 92 bpm”; output examples include “emotion: stress, intensity 0.92”, “emotion: relaxation, intensity 0.35”. The collection unit dynamically sets data collection priority parameters (e.g., traffic congestion information priority=high, sightseeing information priority=low) based on these emotion estimation results, automating control such that congestion information is prioritized during stress, sightseeing information during relaxation, and shortest route information when in a hurry. Furthermore, the collection unit can apply algorithms (e.g., reinforcement learning-based parameter optimization) that determine optimal collection priority by combining emotion estimation results with battery level and communication bandwidth status. The technical effect of the collection unit is that it eliminates subjective human judgment and manual setting for collection priority adjustment, and by realizing automatic optimization that comprehensively considers emotional state, driving situation, and system resources, greatly improves the timeliness, accuracy, and user experience of information provision. Application fields include stress management navigation, driving support systems, personalized information distribution in smart cities, and vehicle fleet management. Unlike conventional human-dependent, fixed-setting data collection, this invention realizes non-conventional, rule-based automatic collection priority control by integrating AI and multimodal emotion estimation technology, thereby contributing to the improvement of computer technology itself.

The collection unit collects other vehicle drivers' driving styles and fatigue levels and utilizes them for traffic congestion prediction. The collection unit collects other vehicle drivers' driving styles and fatigue levels and utilizes them for traffic congestion prediction. For example, the collection unit collects the frequency of sudden brakes and sudden acceleration of other vehicles to analyze driving styles. The collection unit can collect the driving time of other vehicles to estimate driver fatigue levels. The collection unit can predict the risk of congestion occurrence based on the driving styles and fatigue levels of other vehicles. Thus, by collecting other vehicle drivers' driving styles and fatigue levels, the accuracy of traffic congestion prediction is improved. Some or all of the above-described processing in the collection unit may be performed using AI or without using AI. For example, the collection unit can input data on other vehicle drivers' driving styles and fatigue levels into generative AI to utilize them for traffic congestion prediction. Specifically, the collection unit uses V2V communication or cloud collaboration to collect driving behavior data from other vehicles (e.g., number of sudden brakes, number of sudden accelerations, average speed variation, driving time, rest intervals, steering operation patterns, etc.). The collection unit structures these data as time-series tensors (e.g., N×M matrix, N is the number of observation times, M is the number of features) and transmits them to a cloud or local server. When using AI models, the collection unit inputs driving behavior vectors and driving time data to automatically perform preprocessing such as driving style clustering (e.g., automatic classification into aggressive, conservative, or standard types), fatigue level estimation (e.g., scoring based on continuous driving time and rest intervals), and congestion risk prediction (e.g., increased risk when fatigue level is high and sudden brakes are frequent). Input examples for AI include “number of sudden brakes: 5”, “driving time: 3.5 hours”, “steering operation vector: {0.1, 0.3, −0.2}”; output examples from the AI model include “driving style: aggressive”, “fatigue score: 0.82”, “congestion risk score: 0.76”. These outputs are attached as risk indicators or driver profiles when transferring data to subsequent analysis or provision units. The technical effect of the collection unit is that it eliminates manual observation of driving behavior and estimation of fatigue levels by humans, and by automatically collecting and preprocessing vast time-series and multivariate data in real time, greatly improves the freshness, accuracy, and reliability of traffic congestion prediction and risk assessment. In addition, clustering and scoring by AI realize non-conventional, rule-based, data-driven traffic information processing, unlike conventional human-dependent, heuristic information collection. Application fields include urban traffic control, optimization of logistics vehicle operations, automatic extraction of accident-prone locations, and automation of risk assessment for insurance companies. Thus, this invention simultaneously achieves improvement of computer technology itself, namely real-time performance, scalability, accuracy improvement, and reduction of erroneous judgments.

The collection unit also collects the status of surrounding traffic signals and construction information to improve the accuracy of traffic congestion information. The collection unit also collects the status of surrounding traffic signals and construction information to improve the accuracy of traffic congestion information. For example, the collection unit collects the timing of traffic signal changes to predict signal waiting times. The collection unit can collect information on roads under construction to propose detour routes. The collection unit can grasp the occurrence of congestion in detail based on the status of traffic signals and construction information. Thus, by collecting the status of traffic signals and construction information, the accuracy of traffic congestion information is improved. Some or all of the above-described processing in the collection unit may be performed using AI or without using AI. For example, the collection unit can input data on the status of traffic signals and construction information into generative AI to improve the accuracy of traffic congestion information. Specifically, the collection unit collaborates with traffic signal control systems and road construction management systems to obtain the status of traffic signals (e.g., timing of green/yellow/red signals, signal cycle, signal waiting time), construction information (e.g., construction section ID, construction period, road closure flag, construction progress, work time zone, etc.) in real time. The collection unit structures these data as time-series tensors (e.g., N×M matrix, N is the number of observation times, M is the number of features) and transmits them to a cloud or local server. When using AI models, the collection unit inputs signal status vectors and construction information vectors to automatically perform preprocessing such as signal waiting time prediction (e.g., estimation of remaining time until next green signal by RNN), construction impact estimation (e.g., calculation of congestion occurrence probability when passing through construction section), and detour route recommendation (e.g., automatic extraction of routes avoiding construction sections). Input examples for AI include “signal status time series: {red, red, green}”, “construction section ID: 123”, “construction progress: 0.7”; output examples from the AI model include “signal waiting time prediction: 45 seconds”, “construction impact score: 0.65”, “recommended detour route ID: 56”. These outputs are attached as signal waiting predictions or construction impact indicators when transferring data to subsequent analysis or provision units. The technical effect of the collection unit is that it eliminates manual observation of signals and collection of construction information by humans, and by automatically collecting and preprocessing vast time-series and multivariate data in real time, greatly improves the freshness, accuracy, and reliability of traffic congestion and detour route information. In addition, signal waiting prediction and construction impact estimation by AI realize non-conventional, rule-based, data-driven traffic information processing, unlike conventional human-dependent, heuristic information collection. Application fields include urban traffic control, construction congestion avoidance navigation, optimization of logistics vehicle operations, and selection of priority routes for emergency vehicles. Thus, this invention simultaneously achieves improvement of computer technology itself, namely real-time performance, scalability, accuracy improvement, and reduction of erroneous judgments.

The analysis unit estimates a user's emotion and adjusts the display method of analysis results based on the estimated user's emotion. The analysis unit estimates a user's emotion and adjusts the display method of analysis results based on the estimated user's emotion. For example, if the user is nervous, the analysis unit provides a simple and highly visible display method. If the user is relaxed, the analysis unit provides a display method including detailed information. If the user is in a hurry, the analysis unit provides a display method focusing on key points. Thus, by adjusting the display method of analysis results according to the user's emotion, more appropriate information provision becomes possible. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input user emotion data into generative AI to adjust the display method of analysis results. Specifically, the analysis unit simultaneously acquires user voice data (e.g., waveform tensor of conversation audio, 1×16000 samples), face images (224×224×3 image tensor), driving behavior (steering operation time series, pedal force vector), and biometric sensor data (heart rate, skin conductance, etc.), and inputs them into a multimodal generative AI model (speech emotion recognition CNN+facial expression recognition CNN+time-series RNN +text generation LLM). The AI model outputs “emotion label (e.g., nervousness, relaxation, impatience)” and “emotion intensity score (e.g., 0.92)” from these inputs. Input examples include “audio waveform tensor: 1×16000”, “face image tensor: 224×224×3”, “heart rate: 98 bpm”; output examples include “emotion: nervousness, intensity 0.88”, “emotion: relaxation, intensity 0.35”. The analysis unit dynamically sets parameters of the display control module (e.g., information amount level, font size, color emphasis, degree of summarization) based on these emotion estimation results. For example, in a nervous state, a simple key point display such as “congestion occurrence: yes, recommended route: A→B→C” is provided; in a relaxed state, detailed information such as “congestion occurrence: yes (occurrence probability 0.85), recommended route: A→B→C (travel time 23 minutes, congestion 0.72), nearby sightseeing information: XX park” is displayed in multiple layers; in a hurry, only key points such as “shortest route: D→E, travel time: 18 minutes” are emphasized. The analysis unit switches display methods in real time and immediately reflects them in user interfaces (in-vehicle displays, smartphone apps, etc.). Furthermore, the analysis unit can optimize display information (e.g., simplified display when battery is low) by combining emotion estimation results with battery level and communication bandwidth status. The technical effect of the analysis unit is that it eliminates subjective human judgment and manual setting for display switching, and by realizing automatic optimization that comprehensively considers emotional state, driving situation, and system resources, greatly improves the timeliness, accuracy, and user experience of information provision. Application fields include stress management navigation, driving support systems, personalized information distribution in smart cities, and vehicle fleet management. Unlike conventional human-dependent, fixed-setting information display, this invention realizes non-conventional, rule-based automatic display control by integrating AI and multimodal emotion estimation technology, thereby contributing to the improvement of computer technology itself.

The analysis unit analyzes collected data in real time and provides traffic congestion information immediately. The analysis unit analyzes collected data in real time and provides traffic congestion information immediately. For example, the analysis unit analyzes the stop time of a vehicle and changes in speed in real time and immediately notifies the occurrence of congestion. The analysis unit can analyze the status of traffic signals in real time and predict signal waiting times. The analysis unit can analyze construction information in real time and immediately propose detour routes. Thus, real-time data analysis enables immediate provision of traffic congestion information. Some or all of the above-described processing in the analysis unit may be performed using AI or without using AI. For example, the analysis unit can input collected data into an AI model to provide traffic congestion information immediately. Specifically, the analysis unit integrates multidimensional data received from the collection unit, such as stop time of a vehicle (float time-series vector in seconds, e.g., {12.3, 0.0, 5.7, . . . }), changes in vehicle speed (time-series vector, e.g., {50.0, 48.2, 30.1, . . . }), number of sudden brakes (integer value), traffic signal status (time-series labels, e.g., {red, green, yellow}), construction information (construction section ID, progress, road closure flag, etc.), as time-series tensors (N×M matrix, N is the number of observation times, M is the number of features). The analysis unit uses convolutional neural networks (CNN), recurrent neural networks (RNN), or Transformer-based time-series analysis models to output from the input tensor the presence or absence of congestion (binary label: 0=no congestion, 1=congestion), the degree of congestion (continuous score: 0.0-1.0), predicted time of occurrence (e.g., 5 minutes later, 15 minutes later), recommended detour route ID (integer value), signal waiting time prediction (in seconds), and construction impact score (0.0-1.0). Input examples for the AI model include “stop time vector: {10.2, 12.5, 15.0}”, “speed change vector: {50.0, 48.2, 30.1}”, “signal status: {red, green}”, “construction section ID: 123”; output examples include “congestion occurrence probability 0.92”, “recommended route ID: 45”, “signal waiting time prediction: 45 seconds”, “construction impact score: 0.65”. The analysis unit uses these outputs for subsequent processing such as threshold determination (e.g., generating warning information if congestion occurrence probability is 0.7 or higher) and information prioritization (e.g., immediate notification if signal waiting time is long), and ultimately distributes them to navigation systems or driver terminals of other vehicles. During AI model training, the analysis unit uses past congestion occurrence history, road congestion patterns, signal change history, and construction impact data as training data, and optimizes weights by error backpropagation based on loss functions (cross-entropy, MSE, etc.). The analysis unit also automates preprocessing such as anomaly detection, noise removal, and data imputation to improve data quality. The technical effect of the analysis unit is that it eliminates subjective human judgment and manual information analysis, and by automatically analyzing vast time-series and multivariate data in high-dimensional space, greatly improves the accuracy and speed of congestion detection, route recommendation, signal waiting prediction, and construction impact estimation. In addition, distributed processing and edge-cloud collaboration considering communication load achieve both real-time performance and scalability. Application fields include urban traffic control, optimization of logistics vehicle operations, construction congestion avoidance navigation, and selection of priority routes for emergency vehicles. Unlike conventional human-dependent, manual analysis of traffic information, this invention realizes non-conventional, rule-based real-time data analysis by combining AI and edge devices, thereby contributing to the improvement of computer technology itself.

The analysis unit detects anomalies in the current traffic congestion situation by comparing with past congestion data. The analysis unit detects anomalies in the current traffic congestion situation by comparing with past congestion data. For example, the analysis unit compares past congestion data with current data to detect abnormal congestion. The analysis unit can compare past congestion patterns with current patterns to identify abnormal traffic situations. The analysis unit can notify anomalies in the current congestion situation in real time based on past data. Thus, by comparing with past data, anomalies in the current congestion situation can be detected. Some or all of the above-described processing in the analysis unit may be performed using AI or without using AI. For example, the analysis unit can input past congestion data and current data into generative AI to detect anomalies. Specifically, the analysis unit integrates past congestion data (e.g., time-series tensor for the past year, N×M matrix, N is the number of observation times, M is the number of features) and current observation data (e.g., stop time vector for the last hour, speed change vector, number of sudden brakes, weather and road condition data, etc.), and inputs them into an anomaly detection AI model (e.g., AutoEncoder, LSTM for time-series anomaly detection, Variational AutoEncoder, etc.). The AI model learns normal patterns from past data and calculates reconstruction error or likelihood score with current data. Input examples include “past congestion pattern tensor: 365×24×5”, “current data vector: {stop time 12.5, speed 30.1, sudden brakes 2, rainy 1}”; output examples include “anomaly score: 0.82 (anomaly detected if threshold exceeds 0.7)”, “anomaly location: section ID 123”. The analysis unit generates warning information when the anomaly score exceeds the threshold and immediately notifies navigation systems or administrator terminals. Furthermore, the analysis unit can automate anomaly factor analysis (e.g., sudden weather change, construction impact, change in driving style) and proposal of preventive measures (e.g., detour route recommendation) based on anomaly detection results. During AI model training, the analysis unit uses labeled normal and abnormal data and optimizes the model using loss functions (reconstruction error, cross-entropy, etc.). The technical effect of the analysis unit is that it eliminates human heuristics and visual anomaly detection, and by automatically analyzing vast time-series and multivariate data in high-dimensional space, greatly improves the accuracy, speed, and explainability of anomaly congestion detection. Application fields include urban traffic monitoring, anomaly detection in logistics vehicle operations, disaster traffic anomaly monitoring, and automatic anomaly notification in smart cities. Unlike conventional human-dependent, manual anomaly detection, this invention realizes non-conventional, rule-based automatic anomaly detection by integrating AI and time-series analysis technology, thereby contributing to the improvement of computer technology itself.

The analysis unit estimates a user's emotion and determines the priority of analysis results based on the estimated user's emotion. The analysis unit estimates a user's emotion and determines the priority of analysis results based on the estimated user's emotion. For example, if the user is feeling stressed, the analysis unit prioritizes the display of traffic congestion information. If the user is relaxed, the analysis unit prioritizes the display of nearby sightseeing information. If the user is in a hurry, the analysis unit prioritizes the display of shortest route information. Thus, by determining the priority of analysis results according to the user's emotion, more appropriate information provision becomes possible. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input user emotion data into generative AI to determine the priority of analysis results. Specifically, the analysis unit acquires user voice data (conversation audio waveform tensor), face images (224×224×3 image tensor), driving behavior (steering operation time series, pedal force vector), and biometric sensor data (heart rate, skin conductance), and inputs them into a multimodal generative AI model (speech emotion recognition CNN +facial expression recognition CNN+time-series RNN+text generation LLM). The AI model outputs “emotion label (e.g., stress, relaxation, impatience)” and “emotion intensity score (e.g., 0.85)”. Input examples include “audio waveform tensor: 1×16000”, “face image tensor: 224×224×3”, “heart rate: 92 bpm”; output examples include “emotion: stress, intensity 0.92”, “emotion: relaxation, intensity 0.35”. The analysis unit dynamically sets analysis result priority parameters (e.g., traffic congestion information priority=high, sightseeing information priority=low) based on these emotion estimation results, automating control such that congestion information is prioritized during stress, sightseeing information during relaxation, and shortest route information when in a hurry. Furthermore, the analysis unit can apply algorithms (e.g., reinforcement learning-based parameter optimization) that determine optimal display priority by combining emotion estimation results with battery level and communication bandwidth status. The technical effect of the analysis unit is that it eliminates subjective human judgment and manual setting for display priority adjustment, and by realizing automatic optimization that comprehensively considers emotional state, driving situation, and system resources, greatly improves the timeliness, accuracy, and user experience of information provision. Application fields include stress management navigation, driving support systems, personalized information distribution in smart cities, and vehicle fleet management. Unlike conventional human-dependent, fixed-setting information display, this invention realizes non-conventional, rule-based automatic display priority control by integrating AI and multimodal emotion estimation technology, thereby contributing to the improvement of computer technology itself.

The analysis unit integrates data from other vehicles to provide wide-area traffic congestion information. The analysis unit integrates data from other vehicles to provide wide-area traffic congestion information. For example, the analysis unit integrates stop times and changes in speed of other vehicles to provide wide-area traffic congestion information. The analysis unit may also integrate driving styles and fatigue levels of other vehicles to predict the risk of congestion occurrence. Furthermore, the analysis unit may propose wide-area detour routes based on data from other vehicles. By integrating data from other vehicles, wide-area traffic congestion information can be provided. Some or all of the above-described processing in the analysis unit may be performed using AI or without using AI. For example, the analysis unit may input data from other vehicles into a generative AI to generate wide-area traffic congestion information. Specifically, the analysis unit integrates stop time vectors collected from multiple vehicles via V2V communication or cloud collaboration (e.g., per-vehicle float arrays at one-second intervals), speed change vectors, number of sudden brakes, driving style indicators (e.g., aggressive, conservative, standard), fatigue scores, location information (latitude and longitude), weather and road condition data, etc., as time-series tensors (e.g., K×N×M matrices, where K is the number of vehicles, N is the number of observation times, and M is the number of features). The analysis unit inputs these multi-vehicle data into convolutional neural networks (CNN), graph neural networks (GNN), Transformer-based time-series analysis models, etc., and outputs wide-area congestion occurrence (binary label), congestion degree (continuous score), predicted occurrence time, recommended detour route ID, congestion risk map (spatial distribution heatmap), danger location labels, and so on. Examples of AI model inputs include “stop time tensor for 100 vehicles,” “speed change vectors for each vehicle,” “driving style clusters,” and “fatigue scores,” while output examples include “wide-area congestion occurrence probability 0.91,” “recommended detour route ID: 78,” and “congestion risk map: Section A high risk.” The analysis unit utilizes these outputs for subsequent processing such as threshold determination, information prioritization, distribution to navigation systems, and linkage to wide-area traffic control systems. Furthermore, during training, the analysis unit uses time-series data from multiple vehicles and locations as training data and optimizes the model using loss functions such as cross-entropy, MSE, and spatial error. As a technical effect, the analysis unit eliminates manual work and single-vehicle-dependent information analysis, and by automatically analyzing vast multi-vehicle and multi-location data in high-dimensional space, greatly improves the accuracy and speed of wide-area congestion detection, risk prediction, and route recommendation. Application fields include urban traffic control, optimization of wide-area logistics vehicle operations, wide-area traffic information sharing during disasters, and priority route selection for emergency vehicles. Unlike conventional human-dependent and single-vehicle-type information processing, this invention contributes to the improvement of computer technology itself by realizing unconventional, rule-based wide-area traffic information analysis that fuses AI and multi-vehicle data integration technology.

The analysis unit predicts future traffic congestion based on collected data. The analysis unit predicts future traffic congestion based on collected data. For example, the analysis unit predicts the time of future congestion occurrence based on past congestion data. The analysis unit may also predict future congestion locations based on past traffic patterns. Furthermore, the analysis unit may evaluate future congestion risk and propose preventive measures based on past data. By predicting future congestion based on collected data, preventive measures can be proposed. Some or all of the above-described processing in the analysis unit may be performed using AI or without using AI. For example, the analysis unit may input collected data into a generative AI to predict future congestion. Specifically, the analysis unit integrates past congestion data (e.g., one year of time-series tensors, N×M matrices, where N is the number of observation times and M is the number of features) and current observation data (stop time vectors, speed change vectors, number of sudden brakes, weather and road condition data, traffic signal status, construction information, etc.), and inputs them into future prediction AI models (e.g., LSTM for time-series prediction, Transformer, graph neural network GNN, etc.). The AI model outputs future congestion occurrence probability (0.0-1.0), predicted occurrence time (e.g., in 30 minutes, in 1 hour), predicted occurrence section (section ID), and recommended preventive measures (e.g., detour route ID, speed limit proposal, signal control optimization, etc.). Examples of AI model inputs include “past congestion pattern tensor: 365×24×5,” “current data vector: {stop time 12.5, speed 30.1, sudden brakes 2, rain 1, signal red, construction section 123},” and output examples include “future congestion occurrence probability 0.87,” “predicted occurrence time: in 45 minutes,” and “recommended detour route ID: 56.” The analysis unit utilizes these outputs for subsequent processing such as threshold determination (e.g., generating a warning if occurrence probability is 0.7 or higher), linkage to preventive measure proposal modules, and distribution to navigation systems. Furthermore, during training, the analysis unit uses past congestion occurrence history and preventive measure implementation history as training data and optimizes the model using loss functions such as cross-entropy and MSE. As a technical effect, the analysis unit eliminates human heuristics and manual prediction/proposal, and by automatically analyzing and predicting vast time-series and multivariate data in high-dimensional space, greatly improves the accuracy, speed, and adaptability of future congestion prediction and preventive measure proposal. Application fields include urban traffic control, optimization of logistics vehicle operations, traffic prediction during disasters, and automatic traffic control in smart cities. Unlike conventional human-dependent and heuristic-based prediction, this invention contributes to the improvement of computer technology itself by realizing unconventional, rule-based automatic congestion prediction and preventive measure proposal that fuses AI and time-series prediction technology.

The learning unit estimates the user's emotion and selects learning data based on the estimated user's emotion. The learning unit estimates the user's emotion and selects learning data based on the estimated user's emotion. For example, if the user is feeling stressed, the learning unit prioritizes learning data for congestion avoidance. If the user is relaxed, the learning unit prioritizes learning data that includes sightseeing information. If the user is in a hurry, the learning unit prioritizes learning data for the shortest route information. By selecting learning data according to the user's emotion, more appropriate route guidance can be provided. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the learning unit may be performed using AI or without using AI. For example, the learning unit may input the user's emotion data into a generative AI to select learning data. Specifically, the learning unit collects various emotion-related data such as the user's voice data (e.g., conversational audio waveform tensor, 1×16000 samples), facial images (224×224×3 image tensor), driving behavior (steering operation time series, pedal force vector), and biometric sensor data (heart rate, skin conductance), and inputs these into a multimodal generative AI model (audio emotion recognition CNN+facial expression recognition CNN+time-series RNN+text generation LLM). The learning unit obtains outputs from the AI model such as “emotion label (e.g., stress, relaxation, impatience)” and “emotion intensity score (e.g., 0.85).” Examples of inputs include “audio waveform tensor: 1×16000,” “facial image tensor: 224×224×3,” “heart rate: 92 bpm,” and output examples include “emotion: stress, intensity 0.92,” “emotion: relaxation, intensity 0.35.” Based on these emotion estimation results, the learning unit dynamically sets learning data selection parameters (e.g., congestion avoidance data priority=high, sightseeing information data priority=low), and automates control to prioritize congestion avoidance data during stress, sightseeing information data during relaxation, and shortest route information when in a hurry. Furthermore, the learning unit may apply algorithms (e.g., reinforcement learning-based parameter optimization) that combine emotion estimation results with battery level and communication bandwidth status to determine optimal learning data selection. The learning unit uses past driving history (GPS coordinate sequences, speed time series, day-of-week and time labels, weather and road conditions, traffic signal changes, construction information, etc.) as training data and trains deep learning models (Transformer-based time-series prediction models, LSTM, GRU, graph neural networks, etc.). The learning unit uses loss functions such as required time error, congestion degree error, and route selection accuracy, and optimizes model parameters using backpropagation. The learning unit also automates preprocessing such as data augmentation (time-series shift of driving history, synthesis of weather conditions), outlier removal, and feature selection to improve model generalization performance. The trained model receives new driving data (current location, destination, time, weather) as input during inference and outputs optimal route candidates (route ID, required time, congestion score, recommendation reason, etc.). Output examples include “route ID: 12,” “required time: 18 minutes,” “congestion: 0.35.” The learning unit links these outputs to the route recommendation module and navigation display unit to provide optimal route guidance to the user. As a technical effect, the learning unit eliminates subjective human judgment and manual setting in learning data selection, and by realizing automatic optimization that comprehensively considers emotional state, driving conditions, and system resources, greatly improves the accuracy, efficiency, and user experience of route guidance. Application fields include stress management navigation, driving assistance systems, personalized information distribution in smart cities, and vehicle fleet management. Unlike conventional human-dependent and fixed-setting learning data selection, this invention contributes to the improvement of computer technology itself by realizing unconventional, rule-based automatic learning data selection that fuses AI and multimodal emotion estimation technology.

The learning unit learns not only past driving data but also driving data from other vehicles. The learning unit learns not only past driving data but also driving data from other vehicles. For example, the learning unit learns optimal routes based on driving data from other vehicles. The learning unit may also learn driving styles of other vehicles and collect data for congestion avoidance. Furthermore, the learning unit may integrate driving data from other vehicles to perform wide-area congestion prediction. By learning driving data from other vehicles, route guidance based on broader data can be provided. Some or all of the above-described processing in the learning unit may be performed using AI or without using AI. For example, the learning unit may input driving data from other vehicles into a generative AI to learn optimal routes. Specifically, the learning unit integrates driving history data collected from multiple vehicles via V2V communication or cloud collaboration (e.g., per-vehicle GPS coordinate sequences, speed time series, day-of-week and time labels, weather and road conditions, traffic signal changes, construction information, driving style indicators, fatigue scores, etc.) as training data. The learning unit structures these multi-vehicle data as time-series tensors (K×N×M matrices, where K is the number of vehicles, N is the number of observation times, and M is the number of features), and inputs them into deep learning models (Transformer-based time-series prediction models, graph neural networks GNN, LSTM, GRU, etc.). Examples of AI model inputs include “driving history tensor for 100 vehicles,” “driving style clusters for each vehicle,” “fatigue scores,” and “weather data,” while output examples include “wide-area optimal route ID: 78,” “required time prediction: 45 minutes,” and “congestion risk map: Section A high risk.” The learning unit uses loss functions such as required time error, congestion degree error, route selection accuracy, and spatial error, and optimizes model parameters using backpropagation. The learning unit also automates preprocessing such as data augmentation (time-series shift of driving history, synthesis of weather conditions), outlier removal, and feature selection to improve model generalization performance. The trained model receives new driving data (current location, destination, time, weather, driving conditions of other vehicles) as input during inference and outputs optimal route candidates (route ID, required time, congestion score, recommendation reason, etc.). Output examples include “route ID: 12,” “required time: 18 minutes,” “congestion: 0.35.” The learning unit links these outputs to the route recommendation module and navigation display unit to provide optimal route guidance to the user. As a technical effect, the learning unit eliminates subjective human judgment and single-vehicle-dependent information analysis, and by automatically learning vast multi-vehicle and multi-location data in high-dimensional space, greatly improves the accuracy and speed of wide-area congestion detection, risk prediction, and route recommendation. Application fields include urban traffic control, optimization of wide-area logistics vehicle operations, wide-area traffic information sharing during disasters, and priority route selection for emergency vehicles. Unlike conventional human-dependent and single-vehicle-type learning, this invention contributes to the improvement of computer technology itself by realizing unconventional, rule-based wide-area traffic information learning that fuses AI and multi-vehicle data integration technology.

The learning unit learns congestion patterns for specific time periods and days of the week and provides efficient route guidance. The learning unit learns congestion patterns for specific time periods and days of the week and provides efficient route guidance. For example, the learning unit learns congestion patterns for specific time periods and proposes optimal routes. The learning unit may also learn congestion patterns for specific days of the week and provide efficient route guidance. Furthermore, the learning unit may propose optimal detour routes based on congestion patterns for specific time periods and days of the week. By learning congestion patterns for specific time periods and days of the week, efficient route guidance can be provided. Some or all of the above-described processing in the learning unit may be performed using AI or without using AI. For example, the learning unit may input congestion patterns for specific time periods and days of the week into a generative AI to provide efficient route guidance. Specifically, the learning unit uses past driving history data (GPS coordinate sequences, speed time series, day-of-week and time labels, weather and road conditions, traffic signal changes, construction information, etc.) as training data and trains deep learning models (Transformer-based time-series prediction models, LSTM, GRU, etc.). The learning unit provides input data such as “driving history tensor: N×T×F (N is the number of vehicles, T is the time-series length, F is the number of features),” “day and time: Monday 8 a.m. ,” “weather: rain,” “construction section: present,” and obtains outputs such as “optimal route ID,” “required time prediction (e.g., 23 minutes),” and “congestion score (e.g., 0.72).” The learning unit uses loss functions such as required time error, congestion degree error, and route selection accuracy, and optimizes model parameters using backpropagation. The learning unit also automates preprocessing such as data augmentation (time-series shift of driving history, synthesis of weather conditions), outlier removal, and feature selection to improve model generalization performance. The trained model receives new driving data (current location, destination, time, weather) as input during inference and outputs optimal route candidates (route ID, required time, congestion score, recommendation reason, etc.). Output examples include “route ID: 12,” “required time: 18 minutes,” “congestion: 0.35.” The learning unit links these outputs to the route recommendation module and navigation display unit to provide optimal route guidance to the user. As a technical effect, the learning unit eliminates human heuristics and manual route selection, and by automatically learning vast time-series and multivariate data in high-dimensional space, greatly improves the accuracy, efficiency, and adaptability of route guidance. In addition, it can flexibly respond to abnormal weather and sudden traffic fluctuations. Application fields include urban traffic control, optimization of logistics vehicle operations, congestion avoidance in tourist areas, and priority route selection for emergency vehicles. Unlike conventional human-dependent and manual learning-type route guidance, this invention contributes to the improvement of computer technology itself by realizing unconventional, rule-based automatic route guidance that combines AI and time-series analysis technology.

The learning unit estimates the user's emotion and adjusts the frequency of learning based on the estimated user's emotion. The learning unit estimates the user's emotion and adjusts the frequency of learning based on the estimated user's emotion. For example, if the user is feeling stressed, the learning unit increases the learning frequency to provide information quickly. If the user is relaxed, the learning unit lowers the learning frequency to reduce battery consumption. If the user is in a hurry, the learning unit increases the learning frequency to propose optimal routes. By adjusting the frequency of learning according to the user's emotion, more appropriate information provision can be achieved. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the learning unit may be performed using AI or without using AI. For example, the learning unit may input the user's emotion data into a generative AI to adjust the frequency of learning. Specifically, the learning unit collects various emotion-related data such as the user's voice data (conversational audio waveform tensor), facial images (224×224×3 image tensor), driving behavior (steering operation time series, pedal force vector), and biometric sensor data (heart rate, skin conductance), and inputs these into a multimodal generative AI model (audio emotion recognition CNN+facial expression recognition CNN+time-series RNN+text generation LLM). The learning unit obtains outputs from the AI model such as “emotion label (e.g., stress, relaxation, impatience)” and “emotion intensity score (e.g., 0.85).” Examples of inputs include “audio waveform tensor: 1×16000,” “facial image tensor: 224×224×3,” “heart rate: 92 bpm,” and output examples include “emotion: stress, intensity 0.92,” “emotion: relaxation, intensity 0.35.” Based on these emotion estimation results, the learning unit dynamically sets learning frequency parameters (e.g., every 1 minute, every 10 minutes, every 30 minutes), and automates control to increase frequency during stress, decrease frequency during relaxation, and quickly learn shortest route information when in a hurry. Furthermore, the learning unit may apply algorithms (e.g., reinforcement learning-based parameter optimization) that combine emotion estimation results with battery level and communication bandwidth status to determine optimal learning frequency. The learning unit uses past driving history (GPS coordinate sequences, speed time series, day-of-week and time labels, weather and road conditions, traffic signal changes, construction information, etc.) as training data and trains deep learning models (Transformer-based time-series prediction models, LSTM, GRU, etc.). The learning unit uses loss functions such as required time error, congestion degree error, and route selection accuracy, and optimizes model parameters using backpropagation. The learning unit also automates preprocessing such as data augmentation (time-series shift of driving history, synthesis of weather conditions), outlier removal, and feature selection to improve model generalization performance. The trained model receives new driving data (current location, destination, time, weather) as input during inference and outputs optimal route candidates (route ID, required time, congestion score, recommendation reason, etc.). Output examples include “route ID: 12,” “required time: 18 minutes,” “congestion: 0.35.” The learning unit links these outputs to the route recommendation module and navigation display unit to provide optimal route guidance to the user. As a technical effect, the learning unit eliminates subjective human judgment and manual setting in learning frequency adjustment, and by realizing automatic optimization that comprehensively considers emotional state, driving conditions, and system resources, greatly improves the accuracy, efficiency, and user experience of route guidance. Application fields include stress management navigation, driving assistance systems, personalized information distribution in smart cities, and vehicle fleet management. Unlike conventional human-dependent and fixed-setting learning frequency control, this invention contributes to the improvement of computer technology itself by realizing unconventional, rule-based automatic learning frequency control that fuses AI and multimodal emotion estimation technology.

The learning unit learns driving data from different regions and countries and provides global route guidance. The learning unit learns driving data from different regions and countries and provides global route guidance. For example, the learning unit learns driving data from different regions and proposes optimal routes. The learning unit may also learn traffic rules of different countries and provide efficient route guidance. Furthermore, the learning unit may perform wide-area congestion prediction based on global driving data. By learning driving data from different regions and countries, global route guidance can be provided. Some or all of the above-described processing in the learning unit may be performed using AI or without using AI. For example, the learning unit may input driving data from different regions and countries into a generative AI to provide global route guidance. Specifically, the learning unit integrates driving history data collected from various countries and regions (e.g., GPS coordinate sequences, speed time series, day-of-week and time labels, weather and road conditions, traffic signal changes, construction information, local traffic rules, sign information, etc.) as training data. The learning unit structures these multi-region data as time-series tensors (R×N×M matrices, where R is the number of regions/countries, N is the number of observation times, and M is the number of features), and inputs them into deep learning models (multilingual Transformer, graph neural networks GNN, LSTM, etc.). Examples of AI model inputs include “driving history tensor for 10 countries,” “traffic rule vectors for each country,” “sign image tensors,” while output examples include “global optimal route ID: 123,” “required time prediction: 120 minutes,” and “local traffic rule compliance score: 0.98.” The learning unit uses loss functions such as required time error, congestion degree error, route selection accuracy, and traffic rule compliance score, and optimizes model parameters using backpropagation. The learning unit also automates preprocessing such as data augmentation (time-series shift of driving history, synthesis of weather conditions, rotation and scaling of sign images), outlier removal, and feature selection to improve model generalization performance. The trained model receives new driving data (current location, destination, time, weather, local traffic rules) as input during inference and outputs optimal route candidates (route ID, required time, congestion score, recommendation reason, etc.). Output examples include “route ID: 45,” “required time: 90 minutes,” “congestion: 0.42.” The learning unit links these outputs to the route recommendation module and navigation display unit to provide global route guidance to the user. As a technical effect, the learning unit eliminates subjective human judgment and region-limited information analysis, and by automatically learning vast multi-region and multi-country data in high-dimensional space, greatly improves the accuracy and speed of global congestion detection, risk prediction, and route recommendation. Application fields include optimization of international logistics vehicle operations, navigation for overseas travelers, global fleet management, and international traffic information sharing during disasters. Unlike conventional human-dependent and region-limited learning, this invention contributes to the improvement of computer technology itself by realizing unconventional, rule-based global traffic information learning that fuses AI and multi-region data integration technology.

The learning unit provides customized route guidance based on the user's driving style and preferences. The learning unit provides customized route guidance based on the user's driving style and preferences. For example, the learning unit learns the user's driving style and proposes optimal routes. The learning unit may also propose routes including sightseeing information based on the user's preferences. Furthermore, the learning unit may provide customized route guidance based on the user's driving style and preferences. By providing customized route guidance based on the user's driving style and preferences, more appropriate information provision can be achieved. Some or all of the above-described processing in the learning unit may be performed using AI or without using AI. For example, the learning unit may input the user's driving style and preference data into a generative AI to provide customized route guidance. Specifically, the learning unit collects the user's driving behavior data (e.g., number of sudden brakes, number of sudden accelerations, average speed, steering operation patterns, driving history) and preference data (e.g., sightseeing visit history, restaurant stopover history, scenic priority flag, etc.), and inputs these as training data into deep learning models (Transformer for user profiling, clustering+route recommendation models, etc.). Examples of AI model inputs include “driving style vector: {0.1, 0.3, −0.2},” “sightseeing visit history: ID123, ID456,” “scenic priority flag: 1,” while output examples include “recommended route ID: 34,” “required time: 25 minutes,” and “via sightseeing spot: XX Park.” The learning unit uses loss functions such as user satisfaction score, required time error, and route selection accuracy, and optimizes model parameters using backpropagation. The learning unit also automates preprocessing such as data augmentation (time-series shift of driving history, synthesis of preference data), outlier removal, and feature selection to improve model generalization performance. The trained model receives new driving style and preference data as input during inference and outputs optimal route candidates (route ID, required time, via sightseeing spot, recommendation reason, etc.). Output examples include “route ID: 56,” “required time: 30 minutes,” “via sightseeing spot: ΔΔ Shrine.” The learning unit links these outputs to the route recommendation module and navigation display unit to provide customized route guidance to the user. As a technical effect, the learning unit eliminates subjective human judgment and manual route selection, and by realizing automatic optimization that comprehensively considers user profiles, driving conditions, and preferences, greatly improves the accuracy, efficiency, and user experience of route guidance. Application fields include personalized navigation, guidance systems for tourist areas, driving assistance systems, and information distribution in smart cities. Unlike conventional human-dependent and fixed-setting route guidance, this invention contributes to the improvement of computer technology itself by realizing unconventional, rule-based automatic customized route guidance that fuses AI and user profiling technology.

The determination unit estimates the user's emotion and adjusts the display method of the degree of fault based on the estimated user's emotion. The determination unit estimates the user's emotion and adjusts the display method of the degree of fault based on the estimated user's emotion. For example, if the user is nervous, the determination unit provides a simple and highly visible display method. If the user is relaxed, the determination unit provides a display method including detailed information. If the user is in a hurry, the determination unit provides a display method that emphasizes key points. By adjusting the display method of the degree of fault according to the user's emotion, more appropriate information provision can be achieved. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the determination unit may be performed using AI or without using AI. For example, the determination unit may input the user's emotion data into a generative AI to adjust the display method of the degree of fault. Specifically, the determination unit acquires various emotion-related data simultaneously, such as the user's voice data (e.g., conversational audio waveform tensor, 1×16000 samples), facial images (224×224×3 image tensor), driving behavior (steering operation time series, pedal force vector), and biometric sensor data (heart rate, skin conductance, etc.). The determination unit inputs these multimodal data into a multimodal generative AI model combining audio emotion recognition CNN, facial expression recognition CNN, time-series RNN, and text generation LLM. The determination unit obtains outputs from the AI model such as “emotion label (e.g., nervousness, relaxation, impatience)” and “emotion intensity score (e.g., 0.92).” Examples of inputs include “audio waveform tensor: 1×16000,” “facial image tensor: 224×224×3,” “heart rate: 98 bpm,” and output examples include “emotion: nervousness, intensity 0.88,” “emotion: relaxation, intensity 0.35.” Based on these emotion estimation results, the determination unit dynamically sets parameters of the degree of fault display control module (e.g., information amount level, font size, color emphasis, summary degree, display layout). For example, in a nervous state, a simple key point display such as “degree of fault: vehicle A 70%, vehicle B 30%” is provided; in a relaxed state, detailed information such as “degree of fault: vehicle A 70%, vehicle B 30%, precedent reference ID: 10234, summary: higher degree of fault for right-turning vehicle, related law: Road Traffic Act Article XX” is displayed in multiple layers; and in a hurry, only key points such as “degree of fault: vehicle A 70%, vehicle B 30%, key point: lane change by vehicle A is the main cause” are emphasized. The determination unit switches the display method in real time and immediately reflects it in the user interface (in-vehicle display, smartphone app, etc.). Furthermore, the determination unit can optimize display information (e.g., simplified display when battery is low) by combining emotion estimation results with battery level and communication bandwidth status. During training, the determination unit uses emotion-labeled audio, image, and biometric data as training data and optimizes model parameters using loss functions such as cross-entropy and MSE. The determination unit also automates preprocessing such as data augmentation (adding noise to audio, rotating and scaling images), outlier removal, and feature selection to improve model generalization performance. As a technical effect, the determination unit eliminates subjective human judgment and manual display switching, and by realizing automatic optimization that comprehensively considers emotional state, driving conditions, and system resources, greatly improves the timeliness, accuracy, and user experience of degree of fault information. Application fields include stress management accident response navigation, accident explanation support for insurance companies, precedent reference display for legal departments, and personalized accident information distribution in smart cities. Unlike conventional human-dependent and fixed-setting information display, this invention contributes to the improvement of computer technology itself by realizing unconventional, rule-based automatic display control that fuses AI and multimodal emotion estimation technology.

The determination unit analyzes not only video footage at the moment of the accident but also footage before and after the accident. The determination unit analyzes not only video footage at the moment of the accident but also footage before and after the accident. For example, the determination unit analyzes footage before the accident as well as at the moment of the accident to identify the cause of the accident. The determination unit may also analyze footage after the accident to understand the extent of the impact. Furthermore, the determination unit may integrate and analyze footage before and after the accident to accurately calculate the degree of fault. By analyzing footage before and after the accident, more accurate determination of the degree of fault is possible. Some or all of the above-described processing in the determination unit may be performed using AI or without using AI. For example, the determination unit may input video data before and after the accident into a generative AI to calculate the degree of fault. Specifically, the determination unit integrates various data such as continuous video frames immediately before and after the accident (image tensor: time-series 3D array, e.g., T×224×224×3, where T is the number of frames), vehicle speed (time-series float values), location information (time-series latitude and longitude pairs), driving operation logs (e.g., steering angle, brake and accelerator operation time series), accident occurrence time, weather and road conditions, and inputs them into an AI model. The determination unit uses convolutional neural networks (CNN), 3D-CNN, recurrent neural networks (RNN), or Transformer-based time-series video analysis models to extract time-series changes in accident patterns (e.g., rear-end collision, side collision, collision during right turn, etc.) from footage before and after the accident, and automatically identifies actions causing the accident (e.g., sudden braking, lane change, signal violation) and the extent of the impact after the accident (e.g., secondary damage, vehicle stop position, behavior changes of surrounding vehicles). Examples of AI model inputs include “video tensor before and after the accident: 30 frames ×224×224×3,” “speed time series: {35.2, 32.1, 0.0},” “steering angle time series: {0.0, 0.2, −0.1},” and output examples include “cause of accident: sudden braking by vehicle A,” “accident pattern: rear-end collision,” “extent of impact: 2 vehicles involved,” “degree of fault: vehicle A 70%, vehicle B 30%.” The determination unit automates explanation of accident causes, presentation of grounds for the degree of fault, and matching with precedent databases (e.g., extraction of similar accident IDs, summary generation) based on these outputs. Furthermore, the determination unit links analysis results of footage before and after the accident with accident occurrence time and location information to ensure spatial and temporal consistency at the accident site. During training, the determination unit uses video footage before and after accidents and correct labels (cause of accident, pattern, degree of fault, etc.) as training data and optimizes model parameters using loss functions such as cross-entropy and time-series error. As a technical effect, the determination unit eliminates subjective human judgment and manual video analysis, and by automatically analyzing vast time-series and multivariate video data in high-dimensional space, greatly improves the accuracy and speed of accident cause identification and degree of fault determination. Application fields include automation of accident response for insurance companies, accident cause analysis for legal departments, video analysis for traffic accident investigation agencies, and accident information sharing in smart cities. Unlike conventional human-dependent and manual video analysis, this invention contributes to the improvement of computer technology itself by realizing unconventional, rule-based accident analysis that fuses AI and time-series video analysis technology.

The determination unit refers to different precedent data according to the situation of the accident and determines the degree of fault. The determination unit refers to different precedent data according to the situation of the accident and determines the degree of fault. For example, the determination unit refers to similar precedent data according to the situation of the accident and determines the degree of fault. The determination unit may also combine different precedent data according to the situation of the accident to calculate the degree of fault. Furthermore, the determination unit may refer to the latest precedent data according to the situation of the accident and determine the degree of fault. By referring to different precedent data according to the situation of the accident, more accurate determination of the degree of fault is possible. Some or all of the above-described processing in the determination unit may be performed using AI or without using AI. For example, the determination unit may input accident situation data into a generative AI to refer to appropriate precedent data and determine the degree of fault. Specifically, the determination unit integrates accident situation data (e.g., accident video tensor, vehicle speed, location information, accident occurrence time, weather and road conditions, driving styles of related vehicles, number of sudden brakes, etc.), and inputs them into natural language processing models (Transformer-based text classifiers and summarization models) or vector search algorithms (e.g., k-NN, cosine similarity calculation). The determination unit vectorizes accident situation descriptions and precedent summaries, and automatically extracts similar cases from the precedent database (structured table: accident type, degree of fault, precedent ID, occurrence date, summary of judgment, related laws, etc.). Examples of AI model inputs include “accident situation text: collision during right turn at intersection,” “precedent database: 10,000 cases,” “search query: degree of fault 70% vs 30%,” and output examples include “similar precedent ID: 10234,” “summary: higher degree of fault for right-turning vehicle,” “related law: Road Traffic Act Article XX.” The determination unit combines multiple precedent data to calculate the degree of fault most suitable for the accident situation and simultaneously presents the precedent ID and summary as grounds. Furthermore, the determination unit automates regular updating, quality monitoring, and access control of precedent data to ensure reliability, security, and scalability. During training, the determination unit uses correct labels for accident situation and precedent matching as training data and optimizes model parameters using loss functions such as similarity error and cross-entropy. As a technical effect, the determination unit eliminates subjective human judgment and manual precedent reference, and by automatically searching, summarizing, and matching vast precedent data in high-dimensional space, greatly improves the accuracy, speed, and explainability of degree of fault determination. Application fields include automation of accident response for insurance companies, precedent search support for legal departments, and database operation for traffic accident investigation agencies. Unlike conventional human-dependent and manual precedent reference, this invention contributes to the improvement of computer technology itself by realizing unconventional, rule-based automatic degree of fault determination that fuses AI and database technology.

The determination unit estimates the user's emotion and determines the priority of the degree of fault based on the estimated user's emotion. The determination unit estimates the user's emotion and determines the priority of the degree of fault based on the estimated user's emotion. For example, if the user is feeling stressed, the determination unit prioritizes the determination of the degree of fault. If the user is relaxed, the determination unit provides detailed information while determining the degree of fault. If the user is in a hurry, the determination unit quickly determines the degree of fault. By determining the priority of the degree of fault according to the user's emotion, more appropriate information provision can be achieved. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the determination unit may be performed using AI or without using AI. For example, the determination unit may input the user's emotion data into a generative AI to determine the priority of the degree of fault. Specifically, the determination unit collects various emotion-related data such as the user's voice data (conversational audio waveform tensor), facial images (224×224×3 image tensor), driving behavior (steering operation time series, pedal force vector), and biometric sensor data (heart rate, skin conductance), and inputs these into a multimodal generative AI model (audio emotion recognition CNN +facial expression recognition CNN +time-series RNN +text generation LLM). The determination unit obtains outputs from the AI model such as “emotion label (e.g., stress, relaxation, impatience)” and “emotion intensity score (e.g., 0.85).” Examples of inputs include “audio waveform tensor: 1×16000,” “facial image tensor: 224×224×3,” “heart rate: 92 bpm,” and output examples include “emotion: stress, intensity 0.92,” “emotion: relaxation, intensity 0.35.” Based on these emotion estimation results, the determination unit dynamically sets priority parameters for the degree of fault determination process (e.g., immediate determination priority, detailed information provision priority, key point emphasis priority), and automates prioritizing degree of fault determination during stress, adding detailed information during relaxation, and rapid determination when in a hurry. Furthermore, the determination unit may apply algorithms (e.g., reinforcement learning-based parameter optimization) that combine emotion estimation results with battery level and communication bandwidth status to determine optimal determination priority. As a technical effect, the determination unit eliminates subjective human judgment and manual priority adjustment in determination, and by realizing automatic optimization that comprehensively considers emotional state, driving conditions, and system resources, greatly improves the timeliness, accuracy, and user experience of degree of fault determination. Application fields include stress management accident response navigation, accident explanation support for insurance companies, precedent reference display for legal departments, and personalized accident information distribution in smart cities. Unlike conventional human-dependent and fixed-setting determination priority control, this invention contributes to the improvement of computer technology itself by realizing unconventional, rule-based automatic determination priority control that fuses AI and multimodal emotion estimation technology.

The determination unit integrates data from other vehicles to calculate a more accurate degree of fault. The determination unit integrates data from other vehicles to calculate a more accurate degree of fault. For example, the determination unit integrates speed and location information of other vehicles to calculate the degree of fault. The determination unit may also consider driving styles of other vehicles to determine the degree of fault. Furthermore, the determination unit may analyze the situation of the accident in detail based on data from other vehicles to calculate the degree of fault. By integrating data from other vehicles, a more accurate calculation of the degree of fault is possible. Some or all of the above-described processing in the determination unit may be performed using AI or without using AI. For example, the determination unit may input data from other vehicles into a generative AI to calculate the degree of fault. Specifically, the determination unit integrates multi-vehicle data collected from accident-related and surrounding vehicles via V2V communication or cloud collaboration, such as speed time-series data (e.g., per-vehicle float arrays), location information (time-series latitude and longitude pairs), driving style indicators (e.g., number of sudden brakes, number of sudden accelerations, average speed variation), fatigue scores, accident occurrence time, weather and road conditions, as time-series tensors (K×N×M matrices, where K is the number of vehicles, N is the number of observation times, and M is the number of features). The determination unit inputs these multi-vehicle data into convolutional neural networks (CNN), graph neural networks (GNN), Transformer-based time-series analysis models, etc., and analyzes spatial and temporal relationships of the accident situation in high-dimensional space. Examples of AI model inputs include “speed time-series tensor for 3 vehicles,” “driving style clusters for each vehicle,” “fatigue scores,” and “weather data,” while output examples include “degree of fault: vehicle A 60%, vehicle B 30%, vehicle C 10%,” “main cause of accident: sudden deceleration by vehicle B,” and “extent of impact: 2 vehicles involved.” The determination unit automates explanation of accident situations, presentation of grounds for the degree of fault, and matching with precedent databases based on these outputs. Furthermore, during training, the determination unit uses multi-vehicle and multi-location accident data as training data and optimizes model parameters using loss functions such as cross-entropy, MSE, and spatial error. As a technical effect, the determination unit eliminates subjective human judgment and single-vehicle-dependent information analysis, and by automatically analyzing vast multi-vehicle and multi-location data in high-dimensional space, greatly improves the accuracy and speed of degree of fault determination. Application fields include urban accident analysis, wide-area accident investigation, multi-vehicle accident response for insurance companies, and accident information sharing in smart cities. Unlike conventional human-dependent and single-vehicle-type accident analysis, this invention contributes to the improvement of computer technology itself by realizing unconventional, rule-based degree of fault determination that fuses AI and multi-vehicle data integration technology.

The determination unit applies different analysis algorithms according to the situation of the accident to determine the degree of fault. The determination unit applies different analysis algorithms according to the situation of the accident to determine the degree of fault. For example, the determination unit selects the optimal analysis algorithm according to the situation of the accident to determine the degree of fault. The determination unit may also combine multiple analysis algorithms according to the situation of the accident to calculate the degree of fault. Furthermore, the determination unit may apply the latest analysis algorithms according to the situation of the accident to determine the degree of fault. By applying different analysis algorithms according to the situation of the accident, more accurate determination of the degree of fault is possible. Some or all of the above-described processing in the determination unit may be performed using AI or without using AI. For example, the determination unit may input accident situation data into a generative AI to apply appropriate analysis algorithms and determine the degree of fault. Specifically, the determination unit integrates accident situation data (e.g., accident video tensor, vehicle speed, location information, accident occurrence time, weather and road conditions, driving style indicators, etc.), and through an analysis algorithm selection module, automatically selects or combines the optimal analysis methods from multiple analysis techniques such as convolutional neural networks (CNN), recurrent neural networks (RNN), graph neural networks (GNN), Transformer-based time-series analysis models, and rule-based precedent matching algorithms. The determination unit branches the analysis flow according to the accident situation, using CNN for accident pattern classification, RNN or Transformer for time-series behavior analysis, GNN for causal relationship estimation between related vehicles, and natural language processing models for precedent reference. Examples of AI model inputs include “accident video tensor: 30 frames×224×224×3,” “speed time series: {35.2, 32.1, 0.0},” “driving style vector: {0.1, 0.3, −0.2},” and output examples include “degree of fault: vehicle A 70%, vehicle B 30%,” “main cause of accident: lane change by vehicle A,” “applied algorithm: CNN+GNN.” The determination unit records the grounds for algorithm selection and application history to ensure explainability and reproducibility. Furthermore, during training, the determination unit uses accident situations and corresponding optimal algorithms as training data and optimizes model parameters using loss functions such as algorithm selection error and determination error. As a technical effect, the determination unit eliminates human heuristics and manual algorithm selection, and by automatically applying optimal analysis methods according to the accident situation, greatly improves the accuracy, speed, and adaptability of degree of fault determination. Application fields include automation of accident response for insurance companies, accident analysis support for legal departments, diverse accident analysis for traffic accident investigation agencies, and accident information sharing in smart cities. Unlike conventional human-dependent and fixed-method accident analysis, this invention contributes to the improvement of computer technology itself by realizing unconventional, rule-based automatic degree of fault determination that fuses AI and algorithm selection technology.

The provision unit estimates the user's emotion and adjusts the display method of information to be provided based on the estimated user's emotion. The provision unit estimates the user's emotion and adjusts the display method of information to be provided based on the estimated user's emotion. For example, if the user is nervous, the provision unit provides a simple and highly visible display method. If the user is relaxed, the provision unit provides a display method including detailed information. If the user is in a hurry, the provision unit provides a display method that emphasizes key points. By adjusting the display method of information according to the user's emotion, more appropriate information provision can be achieved. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the provision unit may be performed using AI or without using AI. For example, the provision unit may input the user's emotion data into a generative AI to adjust the display method of information. Specifically, the provision unit acquires the user's voice data (e.g., conversational audio waveform tensor, 1×16000 samples), facial images (224×224×3 image tensor), driving behavior (steering operation time series, pedal force vector), and biometric sensor data (heart rate, skin conductance, etc.) simultaneously, and inputs these into a multimodal generative AI model combining audio emotion recognition CNN, facial expression recognition CNN, time-series RNN, and text generation LLM. Examples of AI model inputs include “audio waveform tensor: 1×16000,” “facial image tensor: 224×224×3,” “heart rate: 98 bpm,” and output examples include “emotion: nervousness, intensity 0.88,” “emotion: relaxation, intensity 0.35.” Based on these emotion estimation results, the provision unit dynamically sets parameters of the display control module (e.g., information amount level, font size, color emphasis, summary degree, display layout). For example, in a nervous state, a simple key point display such as “congestion occurrence: yes, recommended route: A→B→C” is provided; in a relaxed state, detailed information such as “congestion occurrence: yes (occurrence probability 0.85), recommended route: A→B→C (required time 23 minutes, congestion 0.72), surrounding sightseeing information: XX Park” is displayed in multiple layers; and in a hurry, only key points such as “shortest route: D→E, required time: 18 minutes” are emphasized. The provision unit switches the display method in real time and immediately reflects it in the user interface (in-vehicle display, smartphone app, etc.). Furthermore, the provision unit can optimize display information (e.g., simplified display when battery is low) by combining emotion estimation results with battery level and communication bandwidth status. During training, the provision unit uses emotion-labeled audio, image, and biometric data as training data and optimizes model parameters using loss functions such as cross-entropy and MSE. The provision unit also automates preprocessing such as data augmentation (adding noise to audio, rotating and scaling images), outlier removal, and feature selection to improve model generalization performance. As a technical effect, the provision unit eliminates subjective human judgment and manual display switching, and by realizing automatic optimization that comprehensively considers emotional state, driving conditions, and system resources, greatly improves the timeliness, accuracy, and user experience of information provision. Application fields include stress management navigation, driving assistance systems, personalized information distribution in smart cities, and vehicle fleet management. Unlike conventional human-dependent and fixed-setting information display, this invention contributes to the improvement of computer technology itself by realizing unconventional, rule-based automatic display control that fuses AI and multimodal emotion estimation technology.

The provision unit updates information provided to other vehicles in real time. The provision unit updates information provided to other vehicles in real time. For example, the provision unit updates traffic congestion information in real time and provides it to other vehicles. The provision unit may also update the status of traffic signals in real time and provide it to other vehicles. Furthermore, the provision unit may update construction information in real time and provide it to other vehicles. By updating information in real time, the latest information can be provided. Some or all of the above-described processing in the provision unit may be performed using AI or without using AI. For example, the provision unit may input real-time updated information into a generative AI to provide it to other vehicles. Specifically, the provision unit integrates multidimensional data such as stop time of vehicles received from the collection unit or analysis unit (time-series float vector at one-second intervals), changes in vehicle speed (time-series vector), number of sudden brakes, traffic signal status (time-series labels), construction information (construction section ID, progress, road closure flag, etc.) as time-series tensors (N×M matrices, where N is the number of observation times and M is the number of features), and manages them on the cloud or local server. The provision unit inputs these data into convolutional neural networks (CNN), recurrent neural networks (RNN), Transformer-based time-series analysis models, etc., and outputs congestion occurrence, congestion degree, predicted occurrence time, recommended detour route ID, predicted signal waiting time, construction impact score, and so on. Examples of AI model inputs include “stop time vector: {10.2, 12.5, 15.0},” “speed change vector: {50.0, 48.2, 30.1},” “signal status: {red, blue},” “construction section ID: 123,” and output examples include “congestion occurrence probability 0.92,” “recommended route ID: 45,” “predicted signal waiting time: 45 seconds,” “construction impact score: 0.65.” The provision unit distributes these outputs in real time to navigation systems and driver terminals of other vehicles. Furthermore, during training, the provision unit uses past congestion occurrence history, road congestion patterns, signal change history, and construction impact data as training data and optimizes weights using loss functions such as cross-entropy and MSE by backpropagation. The provision unit also automates preprocessing such as anomaly detection, noise removal, and data imputation to improve data quality. As a technical effect, the provision unit eliminates subjective human judgment and manual information updating, and by automatically analyzing and distributing vast time-series and multivariate data in high-dimensional space, greatly improves the freshness, accuracy, and reliability of information provision. Application fields include urban traffic control, optimization of logistics vehicle operations, construction congestion avoidance navigation, and priority route selection for emergency vehicles. Unlike conventional human-dependent and manual updating information provision, this invention contributes to the improvement of computer technology itself by realizing unconventional, rule-based real-time information distribution that fuses AI and edge/cloud collaboration technology.

The provision unit assigns priority to information to be provided and preferentially provides important information. The provision unit assigns priority to information to be provided and preferentially provides important information. For example, the provision unit preferentially provides traffic congestion information and notifies other vehicles. The provision unit may also preferentially provide the status of traffic signals and notify other vehicles. Furthermore, the provision unit may preferentially provide construction information and notify other vehicles. By assigning priority to information, important information can be preferentially provided. Some or all of the above-described processing in the provision unit may be performed using AI or without using AI. For example, the provision unit may input information to be provided into a generative AI to assign priority and provide it. Specifically, the provision unit integrates multidimensional data received from the collection unit or analysis unit (congestion occurrence probability, signal waiting time, construction impact score, danger location labels, etc.), and inputs them into an information priority determination AI model (e.g., multitask classifier, reinforcement learning-based priority optimization model, etc.). Examples of AI model inputs include “congestion occurrence probability: 0.92,” “signal waiting time: 45 seconds,” “construction impact score: 0.65,” and output examples include “information priority: congestion information=high, signal information=medium, construction information=low.” The provision unit automates control to notify other vehicles and user terminals in order of importance based on these priority labels. Furthermore, the provision unit may apply algorithms (e.g., priority optimization under resource constraints) that combine priority determination results with battery level and communication bandwidth status to determine the optimal information distribution order. During training, the provision unit uses past information distribution history and user response data as training data and optimizes model parameters using loss functions such as priority error and distribution delay penalty. As a technical effect, the provision unit eliminates subjective human judgment and manual priority adjustment in information provision, and by realizing automatic optimization that comprehensively considers information importance, system resources, and user status, greatly improves the timeliness, accuracy, and user experience of information provision. Application fields include emergency information distribution, traffic control, optimization of logistics vehicle operations, and information distribution in smart cities. Unlike conventional human-dependent and fixed-setting information priority control, this invention contributes to the improvement of computer technology itself by realizing unconventional, rule-based automatic information priority control that fuses AI and priority optimization technology.

The provision unit estimates the user's emotion and determines the priority of information to be provided based on the estimated user's emotion. The provision unit estimates the user's emotion and determines the priority of information to be provided based on the estimated user's emotion. For example, if the user is feeling stressed, the provision unit preferentially provides traffic congestion information. If the user is relaxed, the provision unit preferentially provides surrounding sightseeing information. If the user is in a hurry, the provision unit preferentially provides shortest route information. By determining the priority of information according to the user's emotion, more appropriate information provision can be achieved. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the provision unit may be performed using AI or without using AI. For example, the provision unit may input the user's emotion data into a generative AI to determine the priority of information. Specifically, the provision unit acquires the user's voice data (conversational audio waveform tensor), facial images (224×224×3 image tensor), driving behavior (steering operation time series, pedal force vector), and biometric sensor data (heart rate, skin conductance), and inputs these into a multimodal generative AI model combining audio emotion recognition CNN, facial expression recognition CNN, time-series RNN, and text generation LLM. Examples of AI model inputs include “audio waveform tensor: 1×16000,” “facial image tensor: 224×224×3,” “heart rate: 92 bpm,” and output examples include “emotion: stress, intensity 0.92,” “emotion: relaxation, intensity 0.35.” Based on these emotion estimation results, the provision unit dynamically sets information priority parameters (e.g., congestion information priority=high, sightseeing information priority=low), and automates control to preferentially provide congestion information during stress, sightseeing information during relaxation, and shortest route information when in a hurry. Furthermore, the provision unit may apply algorithms (e.g., reinforcement learning-based parameter optimization) that combine emotion estimation results with battery level and communication bandwidth status to determine optimal information priority. During training, the provision unit uses emotion-labeled data and information selection history as training data and optimizes model parameters using loss functions such as priority error and user satisfaction score. As a technical effect, the provision unit eliminates subjective human judgment and manual priority adjustment in information provision, and by realizing automatic optimization that comprehensively considers emotional state, driving conditions, and system resources, greatly improves the timeliness, accuracy, and user experience of information provision. Application fields include stress management navigation, driving assistance systems, personalized information distribution in smart cities, and vehicle fleet management. Unlike conventional human-dependent and fixed-setting information priority control, this invention contributes to the improvement of computer technology itself by realizing unconventional, rule-based automatic information priority control that fuses AI and multimodal emotion estimation technology.

The provision unit integrates data from other vehicles to provide wide-area information. The provision unit integrates data from other vehicles to provide wide-area information. For example, the provision unit integrates stop times and changes in speed of other vehicles to provide wide-area traffic congestion information. The provision unit may also integrate driving styles and fatigue levels of other vehicles to predict the risk of congestion occurrence. Furthermore, the provision unit may propose wide-area detour routes based on data from other vehicles. By integrating data from other vehicles, wide-area information provision is possible. Some or all of the above-described processing in the provision unit may be performed using AI or without using AI. For example, the provision unit may input data from other vehicles into a generative AI to generate wide-area information. Specifically, the provision unit integrates stop time vectors collected from multiple vehicles via V2V communication or cloud collaboration (e.g., per-vehicle float arrays at one-second intervals), speed change vectors, number of sudden brakes, driving style indicators (e.g., aggressive, conservative, standard), fatigue scores, location information (latitude and longitude), weather and road condition data, etc., as time-series tensors (K×N×M matrices, where K is the number of vehicles, N is the number of observation times, and M is the number of features). The provision unit inputs these multi-vehicle data into convolutional neural networks (CNN), graph neural networks (GNN), Transformer-based time-series analysis models, etc., and outputs wide-area congestion occurrence (binary label), congestion degree (continuous score), predicted occurrence time, recommended detour route ID, congestion risk map (spatial distribution heatmap), danger location labels, and so on. Examples of AI model inputs include “stop time tensor for 100 vehicles,” “speed change vectors for each vehicle,” “driving style clusters,” and “fatigue scores,” while output examples include “wide-area congestion occurrence probability 0.91,” “recommended detour route ID: 78,” and “congestion risk map: Section A high risk.” The provision unit utilizes these outputs for subsequent processing such as threshold determination, information prioritization, distribution to navigation systems, and linkage to wide-area traffic control systems. Furthermore, during training, the provision unit uses time-series data from multiple vehicles and locations as training data and optimizes the model using loss functions such as cross-entropy, MSE, and spatial error. As a technical effect, the provision unit eliminates manual work and single-vehicle-dependent information analysis, and by automatically analyzing vast multi-vehicle and multi-location data in high-dimensional space, greatly improves the accuracy and speed of wide-area congestion detection, risk prediction, and route recommendation. Application fields include urban traffic control, optimization of wide-area logistics vehicle operations, wide-area traffic information sharing during disasters, and priority route selection for emergency vehicles. Unlike conventional human-dependent and single-vehicle-type information processing, this invention contributes to the improvement of computer technology itself by realizing unconventional, rule-based wide-area traffic information analysis that fuses AI and multi-vehicle data integration technology.

The provision unit collects feedback on information provided and improves the accuracy of the information. The provision unit collects feedback on information provided and improves the accuracy of the information. For example, the provision unit collects feedback from other vehicles to improve the accuracy of traffic congestion information. The provision unit may also improve the accuracy of traffic signal status information based on feedback from other vehicles. Furthermore, the provision unit collects feedback from other vehicles to improve the accuracy of construction information. By collecting feedback, the accuracy of information can be improved. Some or all of the above-described processing in the provision unit may be performed using AI or without using AI. For example, the provision unit may input collected feedback data into a generative AI to improve the accuracy of information. Specifically, the provision unit collects feedback data sent from other vehicles and user terminals (e.g., correctness labels for congestion information, measured values of signal waiting time, perceived congestion level when passing through construction sections, information satisfaction scores, etc.), and inputs these as training data into a feedback analysis AI model (e.g., anomaly detection AutoEncoder, feedback classifier, reinforcement learning-based information optimization model, etc.). Examples of AI model inputs include “congestion information correctness: 1 (accurate),” “measured signal waiting time: 50 seconds,” “construction section congestion level: 0.8,” “satisfaction score: 0.9,” and output examples include “information accuracy correction value: +0.05,” “signal information improvement flag: 1,” “construction information reliability: 0.92.” The provision unit uses these outputs to automatically correct the information database, optimize distribution content, and assign information reliability labels in real time. Furthermore, the provision unit may apply algorithms that combine feedback analysis results with battery level and communication bandwidth status to determine optimal information update frequency and distribution method. During training, the provision unit uses past feedback history and information accuracy correction history as training data and optimizes model parameters using loss functions such as accuracy error and user satisfaction score. As a technical effect, the provision unit eliminates subjective human judgment and manual information accuracy correction, and by automatically analyzing and reflecting vast feedback data in high-dimensional space, greatly improves the accuracy, reliability, and user experience of information provision. Application fields include traffic information distribution services, information optimization in smart cities, operation support for logistics vehicles, and information sharing during disasters. Unlike conventional human-dependent and manual feedback reflection, this invention contributes to the improvement of computer technology itself by realizing unconventional, rule-based automatic information accuracy optimization that fuses AI and feedback analysis technology.

The protection unit estimates a user's emotion and adjusts the data protection method based on the estimated user's emotion. The protection unit estimates a user's emotion and adjusts the data protection method based on the estimated user's emotion. For example, when the user is feeling stressed, the protection unit increases the data protection level to provide a sense of security. When the user is relaxed, the protection unit appropriately adjusts the data protection level. When the user is in a hurry, the protection unit prioritizes rapid data access while maintaining the protection level. By adjusting the data protection method according to the user's emotion, more appropriate data protection can be achieved. Emotion estimation is realized, for example, by using an emotion engine or an emotion estimation function utilizing generative AI. Generative AI may include text generation AI (such as LLM) or multimodal generative AI, but is not limited to these examples. Some or all of the above-described processing in the protection unit may be performed using AI or without using AI. For example, the protection unit may input the user's emotion data into generative AI and adjust the data protection method.

The protection unit not only anonymizes collected data but also manages data access permissions. The protection unit not only anonymizes collected data but also manages data access permissions. For example, the protection unit anonymizes collected data to protect personal information. The protection unit may also manage data access permissions so that only specific users can access the data. The protection unit may periodically review data access permissions to maintain security. By anonymizing data and managing access permissions, data security is improved. Some or all of the above-described processing in the protection unit may be performed using AI or without using AI. For example, the protection unit may input collected data into generative AI to perform anonymization and access permission management.

The protection unit not only encrypts data but also provides a data tampering detection function. The protection unit not only encrypts data but also provides a data tampering detection function. For example, the protection unit encrypts collected data to prevent unauthorized access by third parties. The protection unit may also provide a function to detect data tampering and maintain data integrity. The protection unit may combine data encryption and tampering detection functions to enhance data security. By encrypting data and providing tampering detection functions, data security is enhanced. Some or all of the above-described processing in the protection unit may be performed using AI or without using AI. For example, the protection unit may input collected data into generative AI to perform encryption and tampering detection.

The protection unit estimates a user's emotion and adjusts the data protection level based on the estimated user's emotion. The protection unit estimates a user's emotion and adjusts the data protection level based on the estimated user's emotion. For example, when the user is feeling stressed, the protection unit increases the data protection level to provide a sense of security. When the user is relaxed, the protection unit appropriately adjusts the data protection level. When the user is in a hurry, the protection unit prioritizes rapid data access while maintaining the protection level. By adjusting the data protection level according to the user's emotion, more appropriate data protection can be achieved. Emotion estimation is realized, for example, by using an emotion engine or an emotion estimation function utilizing generative AI. Generative AI may include text generation AI (such as LLM) or multimodal generative AI, but is not limited to these examples. Some or all of the above-described processing in the protection unit may be performed using AI or without using AI. For example, the protection unit may input the user's emotion data into generative AI and adjust the data protection level.

The protection unit integrates data from other vehicles to improve the data protection level. The protection unit integrates data from other vehicles to improve the data protection level. For example, the protection unit integrates data from other vehicles to improve the data protection level. The protection unit may improve the data protection method based on data from other vehicles. The protection unit may integrate data from other vehicles to enhance data security. By integrating data from other vehicles, the data protection level is improved. Some or all of the above-described processing in the protection unit may be performed using AI or without using AI. For example, the protection unit may input data from other vehicles into generative AI to improve the data protection level.

The protection unit collects feedback regarding data protection and improves the protection method. The protection unit collects feedback regarding data protection and improves the protection method. For example, the protection unit collects feedback from users to improve the data protection method. The protection unit may improve the data protection level based on feedback from other vehicles. The protection unit may periodically collect feedback regarding data protection and review the protection method. By collecting feedback, the data protection method can be improved. Some or all of the above-described processing in the protection unit may be performed using AI or without using AI. For example, the protection unit may input collected feedback data into generative AI to improve the protection method.

The management unit estimates a user's emotion and adjusts the management method of precedent data based on the estimated user's emotion. The management unit estimates a user's emotion and adjusts the management method of precedent data based on the estimated user's emotion. For example, when the user is feeling stressed, the management unit simplifies the management method of precedent data. When the user is relaxed, the management unit provides a detailed management method. When the user is in a hurry, the management unit provides a management method that allows rapid access. By adjusting the management method of precedent data according to the user's emotion, more appropriate data management can be achieved. Emotion estimation is realized, for example, by using an emotion engine or an emotion estimation function utilizing generative AI. Generative AI may include text generation AI (such as LLM) or multimodal generative AI, but is not limited to these examples. Some or all of the above-described processing in the management unit may be performed using AI or without using AI. For example, the management unit may input the user's emotion data into generative AI and adjust the management method of precedent data.

The management unit not only manages the update frequency of precedent data but also monitors the quality of the data. The management unit not only manages the update frequency of precedent data but also monitors the quality of the data. For example, the management unit manages the update frequency of precedent data to provide the latest data. The management unit may periodically monitor the quality of precedent data to maintain data accuracy. The management unit may integrally manage the update frequency and quality of precedent data to improve reliability. By managing the update frequency and quality of precedent data, data reliability is improved. Some or all of the above-described processing in the management unit may be performed using AI or without using AI. For example, the management unit may input precedent data into generative AI to manage update frequency and quality.

The management unit not only manages precedent data but also provides a data backup function. The management unit not only manages precedent data but also provides a data backup function. For example, the management unit periodically backs up precedent data to prevent data loss. The management unit may store backup data in a secure location to enhance data protection. The management unit may provide a function to restore backup data to enable rapid data recovery. By providing a data backup function, data loss can be prevented. Some or all of the above-described processing in the management unit may be performed using AI or without using AI. For example, the management unit may input precedent data into generative AI to perform backup and restoration.

The management unit estimates a user's emotion and determines the management priority of precedent data based on the estimated user's emotion. The management unit estimates a user's emotion and determines the management priority of precedent data based on the estimated user's emotion. For example, when the user is feeling stressed, the management unit preferentially manages important precedent data. When the user is relaxed, the management unit preferentially manages detailed precedent data. When the user is in a hurry, the management unit preferentially manages precedent data that can be accessed quickly. By determining the management priority of precedent data according to the user's emotion, more appropriate data management can be achieved. Emotion estimation is realized, for example, by using an emotion engine or an emotion estimation function utilizing generative AI. Generative AI may include text generation AI (such as LLM) or multimodal generative AI, but is not limited to these examples. Some or all of the above-described processing in the management unit may be performed using AI or without using AI. For example, the management unit may input the user's emotion data into generative AI to determine the management priority.

The management unit integrates data from other vehicles to improve the management accuracy of precedent data. The management unit integrates data from other vehicles to improve the management accuracy of precedent data. For example, the management unit integrates data from other vehicles to improve the management accuracy of precedent data. The management unit may improve the management method of precedent data based on data from other vehicles. The management unit may integrate data from other vehicles to improve the reliability of precedent data. By integrating data from other vehicles, the management accuracy of precedent data is improved. Some or all of the above-described processing in the management unit may be performed using AI or without using AI. For example, the management unit may input data from other vehicles into generative AI to improve management accuracy.

The management unit collects feedback regarding the management of precedent data and improves the management method. The management unit collects feedback regarding the management of precedent data and improves the management method. For example, the management unit collects feedback from users to improve the management method of precedent data. The management unit may improve the management accuracy of precedent data based on feedback from other vehicles. The management unit may periodically collect feedback regarding the management of precedent data and review the management method. By collecting feedback, the management method of precedent data can be improved. Some or all of the above-described processing in the management unit may be performed using AI or without using AI. For example, the management unit may input collected feedback data into generative AI to improve the management method.

The system according to the embodiment is not limited to the above-described examples, and various modifications are possible, for example, as follows.

The analysis unit can collect and integrate data from other vehicles to grasp wide-area traffic conditions. For example, the analysis unit can collect and integrate speed and position information of other vehicles to generate wide-area traffic congestion information. The analysis unit may collect and integrate driving styles and fatigue levels of other vehicles to predict the risk of congestion occurrence. The analysis unit may propose wide-area detour routes based on data from other vehicles. By integrating data from other vehicles, wide-area traffic conditions can be grasped and more accurate traffic congestion information can be provided.

The provision unit can estimate a user's emotion and determine the priority of information to be provided based on the estimated user's emotion. For example, when the user is feeling stressed, the provision unit can preferentially provide traffic congestion information. When the user is relaxed, the provision unit can preferentially provide surrounding sightseeing information. When the user is in a hurry, the provision unit can preferentially provide shortest route information. By determining the priority of information according to the user's emotion, more appropriate information provision can be achieved.

The collection unit can also collect data regarding weather and road conditions to improve the accuracy of traffic congestion information. For example, the collection unit can collect road condition data during rainy weather to identify slippery locations. The collection unit may collect road condition data on snowy days to identify locations where snow removal is needed. The collection unit may collect meteorological data such as wind speed and temperature to analyze factors causing congestion. By collecting data on weather and road conditions, the accuracy of traffic congestion information is improved.

The determination unit can analyze not only video footage at the moment of the accident but also footage before and after the accident. For example, the determination unit can analyze footage before the accident as well as at the moment of the accident to identify the cause of the accident. The determination unit may analyze footage after the accident to grasp the extent of the impact. The determination unit may integrate and analyze footage before and after the accident to accurately calculate the degree of fault. By analyzing footage before and after the accident, more accurate determination of the degree of fault is possible.

The learning unit can estimate a user's emotion and select learning data based on the estimated user's emotion. For example, when the user is feeling stressed, the learning unit can preferentially learn data for congestion avoidance. When the user is relaxed, the learning unit can preferentially learn data including sightseeing information. When the user is in a hurry, the learning unit can preferentially learn shortest route information. By selecting learning data according to the user's emotion, more appropriate route guidance can be provided.

The provision unit can integrate data from other vehicles to provide wide-area information. For example, the provision unit can integrate stop time and changes in speed of other vehicles to provide wide-area traffic congestion information. The provision unit may integrate driving styles and fatigue levels of other vehicles to predict the risk of congestion occurrence. The provision unit may propose wide-area detour routes based on data from other vehicles. By integrating data from other vehicles, wide-area information provision is possible.

The protection unit may provide not only data encryption but also a data tampering detection function. For example, the protection unit can encrypt collected data to prevent unauthorized access by third parties. The protection unit may provide a function to detect data tampering and maintain data integrity. The protection unit may combine data encryption and tampering detection functions to enhance data security. By encrypting data and providing tampering detection functions, data security is enhanced.

The management unit can not only manage the update frequency of precedent data but also monitor the quality of the data. For example, the management unit can manage the update frequency of precedent data and provide the latest data. The management unit can periodically monitor the quality of precedent data and maintain the accuracy of the data. Furthermore, the management unit can integrally manage both the update frequency and quality of precedent data to improve reliability. Thus, by managing the update frequency and quality of precedent data, the reliability of the data is enhanced.

The determination unit can estimate a user's emotion and adjust the display method of the degree of fault based on the estimated user's emotion. For example, when the user is tense, the determination unit can provide a simple and highly visible display method. When the user is relaxed, the determination unit can provide a display method including detailed information. When the user is in a hurry, the determination unit can provide a display method that focuses on key points. Thus, by adjusting the display method of the degree of fault according to the user's emotion, more appropriate information provision becomes possible.

The collection unit can collect the driving styles and fatigue levels of other vehicle drivers and utilize them for traffic congestion prediction. For example, the collection unit can collect the frequency of sudden brakes and sudden accelerations of other vehicles and analyze their driving styles. The collection unit can also collect the driving time of other vehicles and estimate the drivers' fatigue levels. Furthermore, the collection unit can predict the risk of traffic congestion occurrence based on the driving styles and fatigue levels of other vehicles. Thus, by collecting the driving styles and fatigue levels of other vehicles, the accuracy of traffic congestion prediction is improved.

The following is a brief description of the processing flow of Example of the Embodiment.

Step 1: The collection unit collects the stop time of a vehicle and the number of AI drive recorders within a specific range. For example, the collection unit measures the stop time of a vehicle in real time and counts the number of AI drive recorders within a specific range in real time.

Step 2: The analysis unit analyzes data collected by the collection unit and provides traffic congestion information. For example, the analysis unit determines the occurrence of congestion based on the collected data and generates traffic congestion information. Furthermore, the analysis unit can predict the occurrence time and degree of congestion based on the collected data and provide traffic congestion information.

Step 3: The learning unit learns from past driving data and provides efficient route guidance. For example, the learning unit proposes an optimal route based on past driving data. Furthermore, the learning unit can learn congestion patterns for specific time periods and days of the week and provide efficient route guidance.

Step 4: The determination unit analyzes traffic accident data and determines the degree of fault. For example, the determination unit analyzes video footage and data at the moment of the accident and calculates the degree of fault by referring to past precedent data. Furthermore, the determination unit can refer to different precedent data according to the situation of the accident and determine the degree of fault.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, learning unit, and determination unit is implemented by at least one of, for example, the smart device 14 and the data processing apparatus 12. For example, the collection unit collects the stop time of a vehicle and the number of nearby AI drive recorders using the camera 42 and communication I/F 44 of the smart device 14. The analysis unit analyzes data collected by, for example, the specific processing unit 290 of the data processing apparatus 12 and provides traffic congestion information. The learning unit learns from past driving data by, for example, the specific processing unit 290 of the data processing apparatus 12 and provides efficient route guidance. The determination unit analyzes traffic accident data by, for example, the specific processing unit 290 of the data processing apparatus 12 and determines the degree of fault. The correspondence between each unit and the device or control unit is not limited to the examples described above and various modifications are possible.

### Second Embodiment

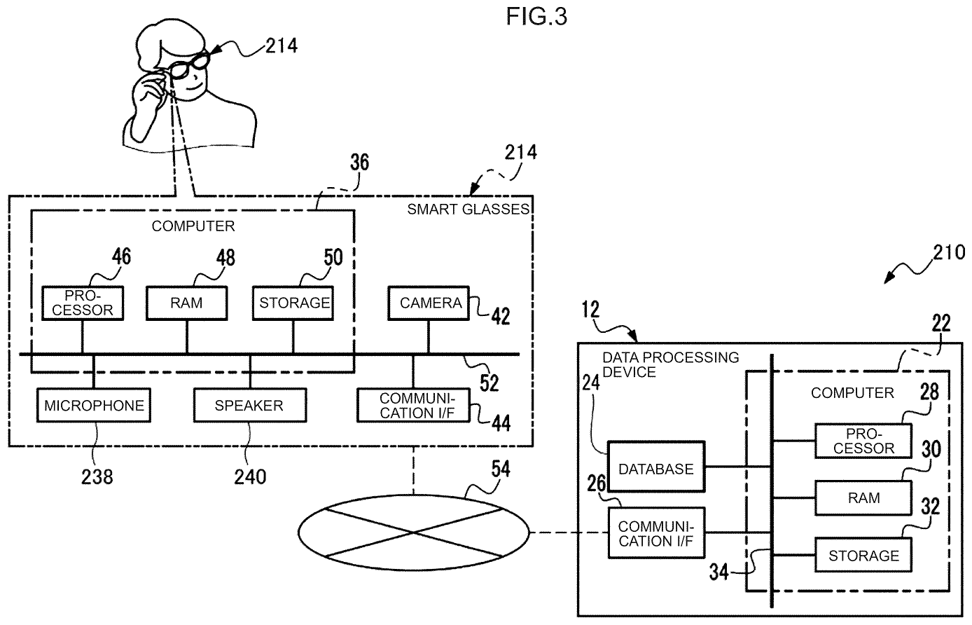

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

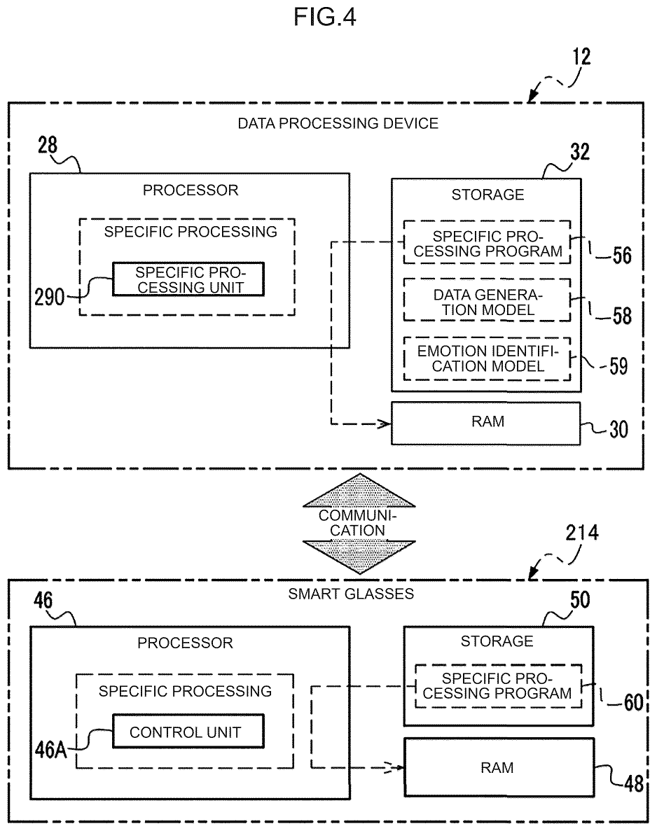

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, learning unit, and determination unit is implemented by at least one of, for example, the smart glasses 214 and the data processing apparatus 12. For example, the collection unit collects the stop time of a vehicle and the number of nearby AI drive recorders using the camera 42 and communication I/F 44 of the smart glasses 214. The analysis unit analyzes data collected by, for example, the specific processing unit 290 of the data processing apparatus 12 and provides traffic congestion information. The learning unit learns from past driving data by, for example, the specific processing unit 290 of the data processing apparatus 12 and provides efficient route guidance. The determination unit analyzes traffic accident data by, for example, the specific processing unit 290 of the data processing apparatus 12 and determines the degree of fault. The correspondence between each unit and the device or control unit is not limited to the examples described above and various modifications are possible.

### Third Embodiment

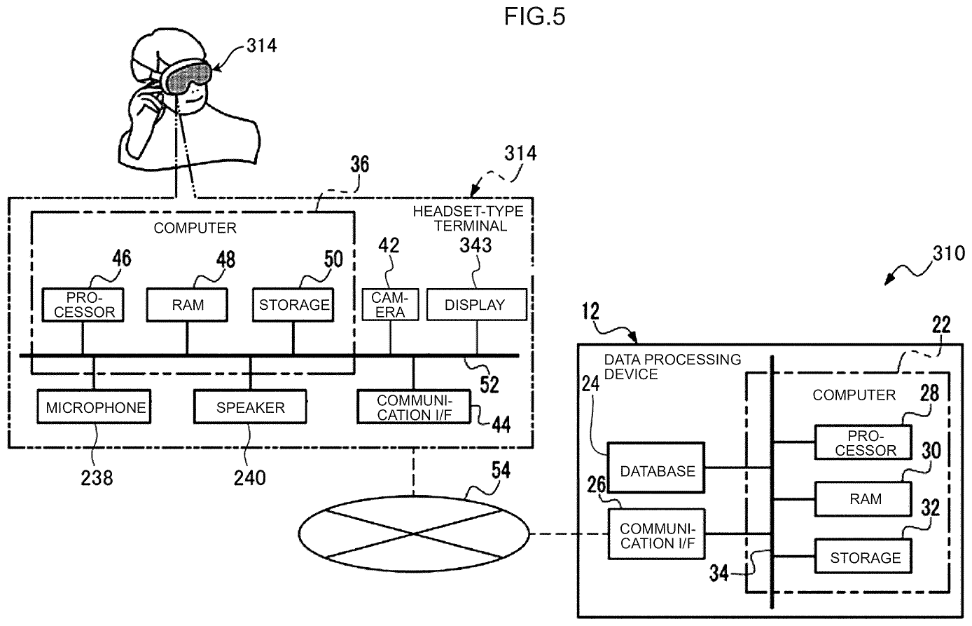

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

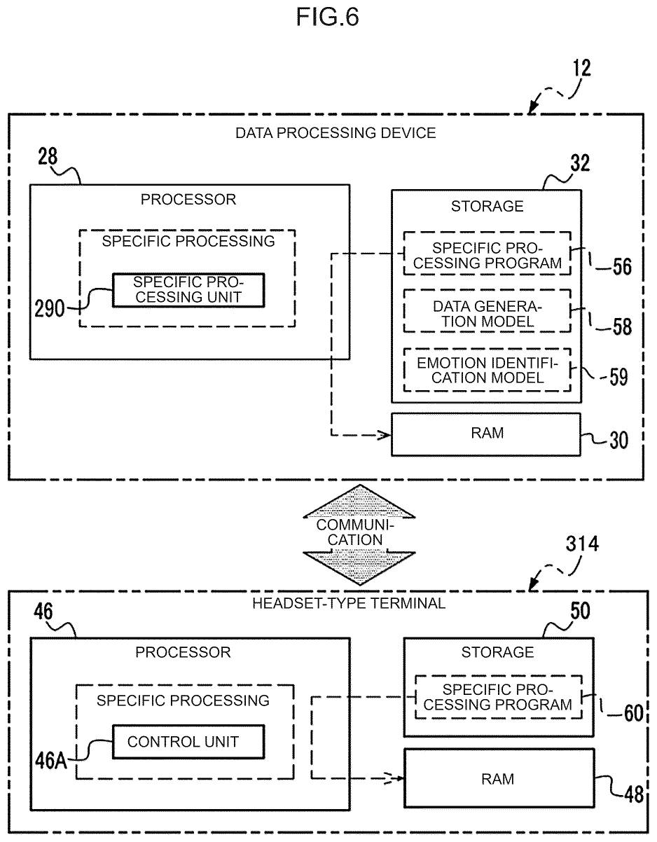

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, learning unit, and determination unit is implemented by at least one of, for example, the headset-type terminal 314 and the data processing apparatus 12. For example, the collection unit collects the stop time of a vehicle and the number of nearby AI drive recorders using the camera 42 and communication I/F 44 of the headset-type terminal 314. The analysis unit analyzes data collected by, for example, the specific processing unit 290 of the data processing apparatus 12 and provides traffic congestion information. The learning unit learns from past driving data by, for example, the specific processing unit 290 of the data processing apparatus 12 and provides efficient route guidance. The determination unit analyzes traffic accident data by, for example, the specific processing unit 290 of the data processing apparatus 12 and determines the degree of fault. The correspondence between each unit and the device or control unit is not limited to the examples described above and various modifications are possible.

### Fourth Embodiment

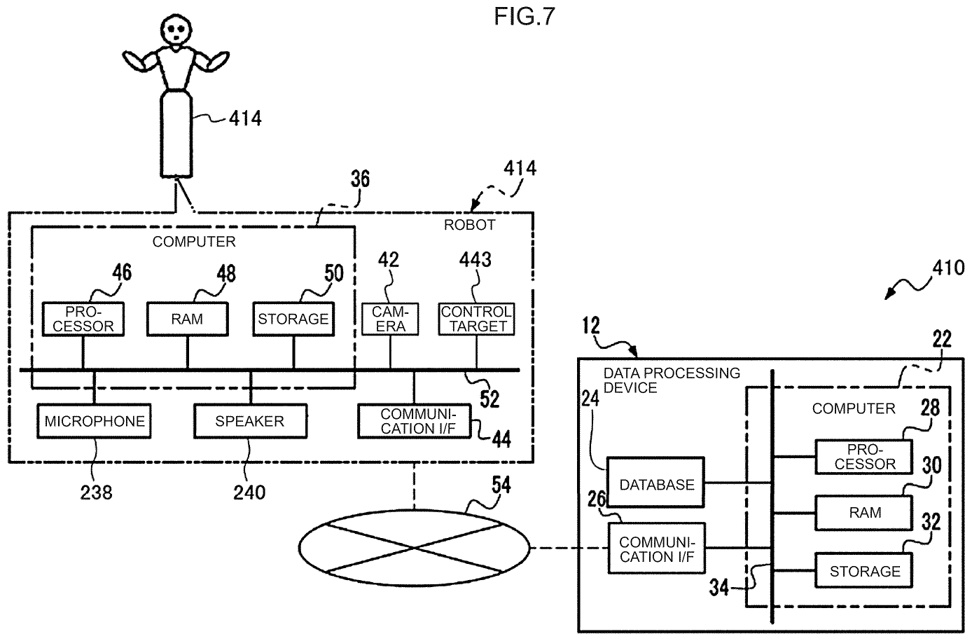

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

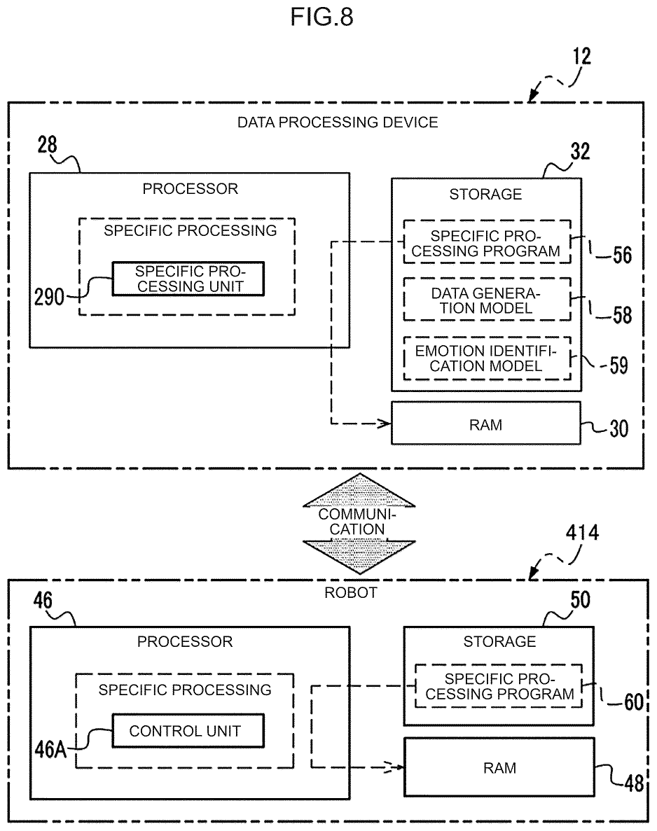

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, learning unit, and determination unit is implemented by at least one of, for example, the robot 414 and the data processing apparatus 12. For example, the collection unit collects the stop time of a vehicle and the number of nearby AI drive recorders using the camera 42 and communication I/F 44 of the robot 414. The analysis unit analyzes data collected by, for example, the specific processing unit 290 of the data processing apparatus 12 and provides traffic congestion information. The learning unit learns from past driving data by, for example, the specific processing unit 290 of the data processing apparatus 12 and provides efficient route guidance. The determination unit analyzes traffic accident data by, for example, the specific processing unit 290 of the data processing apparatus 12 and determines the degree of fault. The correspondence between each unit and the device or control unit is not limited to the examples described above and various modifications are possible.

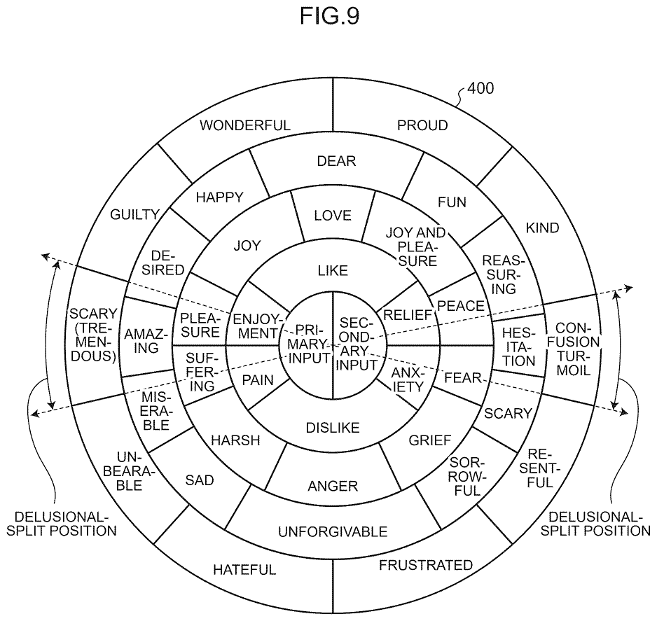

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

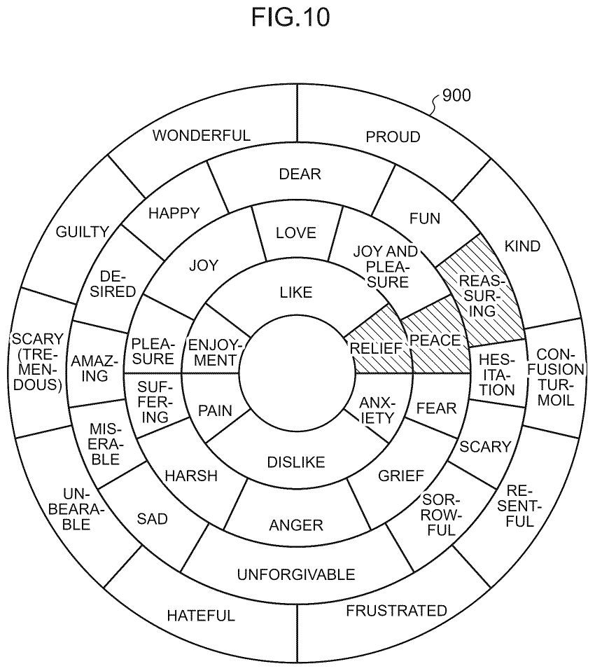

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a collection unit configured to collect the stop time of a vehicle and the number of AI drive recorders within a specific range; an analysis unit configured to analyze data collected by the collection unit and provide traffic congestion information; a learning unit configured to learn from past driving data and provide route guidance; and a determination unit configured to analyze traffic accident data and determine the degree of fault.
(Supplementary Note 2) The system according to Supplementary Note 1, further comprising a provision unit configured to provide data collected by the collection unit to other vehicles.
(Supplementary Note 3) The system according to Supplementary Note 1, further comprising a protection unit configured to anonymize and encrypt data.
(Supplementary Note 4) The system according to Supplementary Note 1, further comprising a management unit configured to manage precedent data.
(Supplementary Note 5) The system according to Supplementary Note 1, wherein the collection unit is configured to collect, in real time, the stop time of a vehicle and the number of nearby AI drive recorders.
(Supplementary Note 6) The system according to Supplementary Note 1, wherein the analysis unit is configured to analyze collected data and provide traffic congestion information.
(Supplementary Note 7) The system according to Supplementary Note 1, wherein the learning unit is configured to learn from past driving data and provide efficient route guidance.
(Supplementary Note 8) The system according to Supplementary Note 1, wherein the determination unit is configured to analyze traffic accident data and determine the degree of fault.
(Supplementary Note 9) The system according to Supplementary Note 1, wherein the collection unit includes a specific method for estimating a user's emotion and adjusting the data collection frequency based on the estimated user's emotion.
(Supplementary Note 10) The system according to Supplementary Note 1, wherein the collection unit is configured to collect not only the stop time of a vehicle but also changes in vehicle speed and the number of sudden brakes.
(Supplementary Note 11) The system according to Supplementary Note 1, wherein the collection unit is configured to also collect data regarding weather and road conditions and improve the accuracy of traffic congestion information.
(Supplementary Note 12) The system according to Supplementary Note 1, wherein the collection unit is configured to estimate a user's emotion and determine the priority of data to be collected based on the estimated user's emotion.
(Supplementary Note 13) The system according to Supplementary Note 1, wherein the collection unit is configured to collect other vehicle drivers' driving styles and fatigue levels and utilize them for traffic congestion prediction.
(Supplementary Note 14) The system according to Supplementary Note 1, wherein the collection unit is configured to also collect the status of surrounding traffic signals and construction information and improve the accuracy of traffic congestion information.
(Supplementary Note 15) The system according to Supplementary Note 1, wherein the analysis unit is configured to estimate a user's emotion and adjust the display method of analysis results based on the estimated user's emotion.
(Supplementary Note 16) The system according to Supplementary Note 1, wherein the analysis unit is configured to analyze collected data in real time and provide traffic congestion information immediately.
(Supplementary Note 17) The system according to Supplementary Note 1, wherein the analysis unit is configured to detect anomalies in the current traffic congestion situation by comparing with past congestion data.
(Supplementary Note 18) The system according to Supplementary Note 1, wherein the analysis unit is configured to estimate a user's emotion and determine the priority of analysis results based on the estimated user's emotion.
(Supplementary Note 19) The system according to Supplementary Note 1, wherein the analysis unit is configured to integrate data from other vehicles and provide wide-area traffic congestion information.
(Supplementary Note 20) The system according to Supplementary Note 1, wherein the analysis unit is configured to predict future traffic congestion based on collected data.
(Supplementary Note 21) The system according to Supplementary Note 1, wherein the learning unit is configured to estimate a user's emotion and select learning data based on the estimated user's emotion.
(Supplementary Note 22) The system according to Supplementary Note 1, wherein the learning unit is configured to learn not only from past driving data but also from driving data of other vehicles.
(Supplementary Note 23) The system according to Supplementary Note 1, wherein the learning unit is configured to learn congestion patterns for specific time periods and days of the week and provide efficient route guidance.
(Supplementary Note 24) The system according to Supplementary Note 1, wherein the learning unit is configured to estimate a user's emotion and adjust the frequency of learning based on the estimated user's emotion.
(Supplementary Note 25) The system according to Supplementary Note 1, wherein the learning unit is configured to learn driving data from different regions and countries and provide global route guidance.
(Supplementary Note 26) The system according to Supplementary Note 1, wherein the learning unit is configured to provide customized route guidance based on the user's driving style and preferences.
(Supplementary Note 27) The system according to Supplementary Note 1, wherein the determination unit is configured to estimate a user's emotion and adjust the display method of the degree of fault based on the estimated user's emotion.
(Supplementary Note 28) The system according to Supplementary Note 1, wherein the determination unit is configured to analyze not only video footage at the moment of the accident but also footage before and after the accident.
(Supplementary Note 29) The system according to Supplementary Note 1, wherein the determination unit is configured to refer to different precedent data according to the situation of the accident and determine the degree of fault.
(Supplementary Note 30) The system according to Supplementary Note 1, wherein the determination unit is configured to estimate a user's emotion and determine the priority of the degree of fault based on the estimated user's emotion.
(Supplementary Note 31) The system according to Supplementary Note 1, wherein the determination unit is configured to integrate data from other vehicles and calculate a more accurate degree of fault.
(Supplementary Note 32) The system according to Supplementary Note 1, wherein the determination unit is configured to apply different analysis algorithms according to the situation of the accident and determine the degree of fault.
(Supplementary Note 33) The system according to Supplementary Note 2, wherein the provision unit is configured to estimate a user's emotion and adjust the display method of information to be provided based on the estimated user's emotion.
(Supplementary Note 34) The system according to Supplementary Note 2, wherein the provision unit is configured to update information provided to other vehicles in real time.
(Supplementary Note 35) The system according to Supplementary Note 2, wherein the provision unit is configured to assign priority to information to be provided and preferentially provide important information.
(Supplementary Note 36) The system according to Supplementary Note 2, wherein the provision unit is configured to estimate a user's emotion and determine the priority of information to be provided based on the estimated user's emotion.
(Supplementary Note 37) The system according to Supplementary Note 2, wherein the provision unit is configured to integrate data from other vehicles and provide wide-area information.
(Supplementary Note 38) The system according to Supplementary Note 2, wherein the provision unit is configured to collect feedback on information provided and improve the accuracy of the information.
(Supplementary Note 39) The system according to Supplementary Note 3, wherein the protection unit is configured to estimate a user's emotion and adjust the data protection method based on the estimated user's emotion.
(Supplementary Note 40) The system according to Supplementary Note 3, wherein the protection unit is configured not only to anonymize collected data but also to manage data access permissions.
(Supplementary Note 41) The system according to Supplementary Note 3, wherein the protection unit is configured not only to encrypt data but also to provide a data tampering detection function.
(Supplementary Note 42) The system according to Supplementary Note 3, wherein the protection unit is configured to estimate a user's emotion and adjust the data protection level based on the estimated user's emotion.
(Supplementary Note 43) The system according to Supplementary Note 3, wherein the protection unit is configured to integrate data from other vehicles and improve the data protection level.
(Supplementary Note 44) The system according to Supplementary Note 3, wherein the protection unit is configured to collect feedback regarding data protection and improve the protection method.
(Supplementary Note 45) The system according to Supplementary Note 4, wherein the management unit is configured to estimate a user's emotion and adjust the management method of precedent data based on the estimated user's emotion.
(Supplementary Note 46) The system according to Supplementary Note 4, wherein the management unit is configured not only to manage the update frequency of precedent data but also to monitor the quality of the data.
(Supplementary Note 47) The system according to Supplementary Note 4, wherein the management unit is configured not only to manage precedent data but also to provide a data backup function.
(Supplementary Note 48) The system according to Supplementary Note 4, wherein the management unit is configured to estimate a user's emotion and determine the management priority of precedent data based on the estimated user's emotion.
(Supplementary Note 49) The system according to Supplementary Note 4, wherein the management unit is configured to integrate data from other vehicles and improve the management accuracy of precedent data.
(Supplementary Note 50) The system according to Supplementary Note 4, wherein the management unit is configured to collect feedback regarding the management of precedent data and improve the management method.

What is claimed is:

1. A system comprising:
circuitry configured to:
receive, from a plurality of edge devices communicating over a packet-switched network, time-series sensor data comprising a temporal duration vector and a device-count value indicating a number of peer edge devices detected within a predetermined spatial range;
generate, by inputting the time-series sensor data into a first neural network comprising a convolutional neural network or a recurrent neural network, a classification output comprising a binary detection label and a continuous severity score;
generate, by inputting historical navigation data into a trained time-series prediction model comprising a Transformer-based architecture, optimal path data comprising a path identifier, an estimated traversal duration, and a congestion score;
generate, by inputting event image tensors and structured reference data into an image recognition model, attribution scores for a plurality of entities associated with an event; and
transmit the classification output, the optimal path data, and the attribution scores to at least one of the plurality of edge devices via the packet-switched network.

2. The system according to claim 1, wherein the circuitry is further configured to transmit the time-series sensor data received from a first edge device to a second edge device of the plurality of edge devices via the packet-switched network.

3. The system according to claim 1, wherein the circuitry is further configured to anonymize the time-series sensor data by applying a masking algorithm to remove device-identifying attributes, and encrypt the anonymized time-series sensor data before storing the encrypted data in a database.

4. The system according to claim 1, wherein the circuitry is further configured to store the structured reference data in a database, and periodically update the structured reference data by retrieving new reference entries from an external data source via the packet-switched network.

5. The system according to claim 1, wherein the time-series sensor data is received in real time from the plurality of edge devices, and the temporal duration vector comprises float values representing duration measurements in seconds.

6. The system according to claim 1, wherein the classification output further comprises a predicted occurrence time indicating an estimated future time at which a detected condition will occur.

7. The system according to claim 1, wherein the historical navigation data comprises GPS coordinate sequences, speed time-series vectors, and temporal context labels, and the trained time-series prediction model is trained using error backpropagation with a loss function comprising at least one of cross-entropy loss or mean squared error loss.

8. The system according to claim 1, wherein the image recognition model comprises a ResNet architecture, and the structured reference data comprises a table storing event type labels, attribution percentages, and reference identifiers.

9. The system according to claim 1, wherein the circuitry is further configured to estimate an emotion of a user by applying an emotion identification model to sensor data received from one of the plurality of edge devices, and adjust a data collection frequency for the time-series sensor data based on the estimated emotion.

10. The system according to claim 1, wherein the time-series sensor data further comprises a speed-change vector representing changes in velocity over time and a sudden-deceleration count value representing a number of rapid deceleration events.

11. The system according to claim 1, wherein the time-series sensor data further comprises weather condition labels and road surface condition values, and the first neural network is configured to process the weather condition labels and road surface condition values together with the temporal duration vector to generate the classification output.

12. The system according to claim 1, wherein the circuitry is further configured to estimate an emotion of a user by applying an emotion identification model to multimodal input data comprising at least one of voice waveform data, facial image data, or biometric sensor data received from one of the plurality of edge devices, and determine a priority of data collection categories based on the estimated emotion.

13. The system according to claim 1, wherein the circuitry is further configured to collect driving behavior data from the plurality of edge devices via vehicle-to-vehicle communication, the driving behavior data comprising a sudden-deceleration count, a sudden-acceleration count, and a continuous operation duration, and generate a driving style classification and a fatigue score by inputting the driving behavior data into a clustering model.

14. The system according to claim 1, wherein the circuitry is further configured to collect traffic signal status data and construction zone information from infrastructure sensors communicating over the packet-switched network, and input the traffic signal status data and construction zone information together with the time-series sensor data into the first neural network to generate the classification output.

15. The system according to claim 1, wherein the circuitry is further configured to generate, by inputting the classification output into a threshold determination module, warning information when the continuous severity score exceeds a predetermined threshold value, and transmit the warning information to the plurality of edge devices via the packet-switched network.

16. The system according to claim 1, wherein the circuitry is further configured to apply a precedent matching algorithm comprising a k-nearest neighbor similarity calculation to compare the event image tensors with the structured reference data, and extract a reference identifier corresponding to a most similar reference entry.

17. The system according to claim 1, wherein the trained time-series prediction model further comprises at least one of a long short-term memory network or a graph neural network, and the optimal path data further comprises a recommendation reason indicating factors contributing to path selection.

18. A system comprising:
circuitry configured to:
receive, from a plurality of edge devices communicating over a packet-switched network, time-series sensor data structured as a multidimensional tensor having dimensions N by M, where N represents a number of observation timestamps and M represents a number of feature channels, the time-series sensor data comprising a temporal duration vector of float values in seconds, a device-count value of integer type, a speed-change vector, and a sudden-deceleration count;
preprocess the time-series sensor data by applying anomaly detection to identify outlier values and noise removal to filter the time-series sensor data;
generate, by inputting the preprocessed time-series sensor data into a convolutional neural network or a recurrent neural network trained using error backpropagation with a cross-entropy loss function, a classification output comprising a binary detection label, a continuous severity score in a range of 0.0 to 1.0, and a predicted occurrence time;
generate, by inputting historical navigation data comprising GPS coordinate sequences, speed time-series vectors, day-of-week labels, time labels, and weather condition data into a Transformer-based time-series prediction model, optimal path data comprising a path identifier, an estimated traversal duration, a congestion score, and a recommendation reason;
generate, by inputting event image tensors of dimension 224 by 224 by 3, location coordinate pairs, and structured reference data into an image recognition model comprising a ResNet architecture, and applying a precedent matching algorithm comprising a similarity calculation to the structured reference data, attribution scores for a plurality of entities and a reference identifier corresponding to a matching reference entry; and
transmit the classification output, the optimal path data, and the attribution scores to at least one of the plurality of edge devices via the packet-switched network.

19. The system according to claim 18, wherein the circuitry is further configured to estimate an emotion of a user by applying an emotion identification model to multimodal input data comprising voice waveform data and facial image data received from one of the plurality of edge devices, and adjust at least one of a data collection frequency or a display format of the classification output based on the estimated emotion.

20. A method performed by circuitry of a system, comprising:
receiving, from a plurality of edge devices communicating over a packet-switched network, time-series sensor data comprising a temporal duration vector and a device-count value indicating a number of peer edge devices detected within a predetermined spatial range;
generating, by inputting the time-series sensor data into a first neural network comprising a convolutional neural network or a recurrent neural network, a classification output comprising a binary detection label and a continuous severity score;
generating, by inputting historical navigation data into a trained time-series prediction model comprising a Transformer-based architecture, optimal path data comprising a path identifier, an estimated traversal duration, and a congestion score;
generating, by inputting event image tensors and structured reference data into an image recognition model, attribution scores for a plurality of entities associated with an event; and
transmitting the classification output, the optimal path data, and the attribution scores to at least one of the plurality of edge devices via the packet-switched network.
